(19) United States
(12) Patent Application Publication
(10) Pub. No.: US 2024/0169590 A1
(43) Pub. Date: May 23, 2024

(54) INFORMATION PROCESSING APPARATUS, INFORMATION PROCESSING METHOD, AND STORAGE MEDIUM

(71) Applicant: SONY GROUP CORPORATION, TOKYO (JP)

(72) Inventors: ATSUSHI ISHIHARA, TOKYO (JP); HIROYUKI AGA, TOKYO (JP)

(21) Appl. No.: 18/550,753

(22) PCT Filed: Feb. 18, 2022
(86) PCT No.: PCT/JP2022/006671

§ 371 Date: Sep. 15, 2023

(30) Foreign Application Priority Data
Mar. 26, 2021 (JP) 2021-053061

(51) Int. Cl. G06T 7/80; G02B 27/01; G06F 3/01; G06T 7/70

(52) U.S. Cl. CPC G06T 7/80; G02B 27/0172; G06F 3/012; G06T 7/70; G02B 2027/0138; G06T 2207/30204; G06T 2207/30244; G06T 2207/30268

(57) ABSTRACT

An information processing apparatus includes an acquiring section that acquires first estimation information representing a position and a posture of a display section estimated on the basis of a first captured image captured with a first camera worn by a user along with the display section, and second estimation information representing a position and a posture of the display section estimated on the basis of a second captured image captured with a second camera installed in a space where the user exists, and a calibration processing section that generates correction information used for calibration of a parameter of either the first camera or the second camera on the basis of the first estimation information and the second estimation information.

### TECHNICAL FIELD

The present technology relates to the technical field of information processing apparatuses, information processing methods and storage media for performing calibration for appropriately estimating a position and a posture of equipment that a user is wearing.

### BACKGROUND ART

It is important to arrange virtual objects at desired locations in order to allow a user to experience an augmented reality space via a display section mounted on a head mounted display (hereinafter, described as an “HMD”) or the like.

It is necessary to estimate the position and posture of the HMD itself in the real world correctly in order to arrange the virtual objects at the desired positions. If the estimated position and posture of itself are not accurate, it is not possible to arrange the virtual objects at the desired positions.

The accuracy of the estimation of the position and posture of itself is based on correctness of various types of parameters (e.g., an optical-axis direction, focal length, etc.) of a camera or the like included in the HMD, and accordingly a process of calculating parameters of the camera included in the HMD is performed at the time of factory shipment or the like.

However, since parameters of the camera can change due to aging or depending on the use environment, it is not always a case that various types of parameters are necessarily optimum at the time when a user uses the camera.

The technology described in PTL 1 described below is one that has been made taking such a circumstance into consideration, and PTL 1 discloses a technology to estimate various types of parameters of a camera mounted on an HMD at the time of use of the HMD, without making a user who has the HMD on aware of it.

### CITATION LIST

### Patent Literature

### [PTL 1]

PCT Patent Publication No. WO2020/017327

### SUMMARY

### Technical Problems

Meanwhile, as for an HMD having a camera mounted thereon, it is possible to arrange virtual objects at more accurate positions by estimating a positional relation between a display section and the camera of the HMD correctly.

For example, in order to estimate the positional relation between a display section and a camera of an HMD correctly, in one technology in the past, observation cameras are arranged at positions corresponding to eyes of a user who has the HMD on, and image-capturing results of the camera of the HMD and the observation cameras are compared.

However, it is not easy to install the observation cameras, and estimate the positional relation between the display section and the camera, and a dedicated environment becomes necessary. In addition, even if estimation at the time of factory shipment is possible, it is not realistic to perform estimation using similar configuration at the time of use by a user.

The present technology has been made in view of such problems, and an object thereof is to propose an information processing apparatus that can calibrate various types of parameters in order to estimate the position and posture about wearable equipment such as an HMD correctly.

### Solution to Problems

An information processing apparatus according to the present technology includes an acquiring section that acquires first estimation information representing a position and a posture of a display section that are estimated on the basis of a first captured image captured with a first camera worn by a user along with the display section, and second estimation information representing a position and a posture of the display section that are estimated on the basis of a second captured image captured with a second camera installed in a space where the user exists, and a calibration processing section that generates correction information used for calibration of a parameter of either the first camera or the second camera on the basis of the first estimation information and the second estimation information.

Thereby, it becomes possible to calibrate parameters used for estimation of the position and the posture of the display section without arranging observation cameras for calibration arranged at positions corresponding to the eyes of a user.

### BRIEF DESCRIPTION OF DRAWINGS

FIG. 1 is a figure depicting a state where a user who has an HMD on is positioned in a cabin space as a target space.

FIG. 2 is a figure schematically depicting a positional relation between a first camera and a second camera in a first mode and a second mode.

FIG. 3 is a block diagram depicting a configuration example of the HMD.

FIG. 4 is a block diagram depicting a configuration example of a vehicle system.

FIG. 5 is a schematic diagram depicting the positional relation among sections of the HMD and sections of the vehicle system.

FIG. 6 is an explanatory diagram depicting a state where a virtual object VOB as navigation information on a windshield of a vehicle is superimposition-displayed.

FIG. 7 is an explanatory diagram depicting a state where a virtual object VOB is superimposition-displayed on a controller arranged on a dashboard of the vehicle.

FIG. 8 is a flowchart depicting an example of a process executed by the HMD, along with FIG. 9.

FIG. 9 is a flowchart depicting the example of the process executed by the HMD, along with FIG. 8.

FIG. 10 is a flowchart depicting an example of a process executed by the vehicle system.

FIG. 11 is a figure for explaining that each parameter is stored for each temperature range.

FIG. 12 is a flowchart depicting an example of a process executed by the HMD in a second embodiment, along with FIG. 13.

FIG. 13 is a flowchart depicting the example of the process executed by the HMD in the second embodiment, along with FIG. 12.

FIG. 14 is a diagram depicting an example of a second captured image captured for determining whether or not calibration is necessary.

FIG. 15 is a figure depicting an example of the relation among the position of a virtual object decided on the basis of first estimation information, the position of a virtual object decided on the basis of second estimation information and the actual position of the steering wheel in a third embodiment.

FIG. 16 is a figure depicting an example of the relation between the position of a virtual object decided on the basis of third estimation information generated from the first estimation information and the second estimation information and the actual position of the steering wheel.

FIG. 17 is a flowchart depicting an example of a process executed by the HMD in a modification example, along with FIG. 8.

FIG. 18 is a flowchart depicting an example of a process executed by the HMD in another modification example.

### DESCRIPTION OF EMBODIMENTS

Hereinbelow, embodiments according to the present technology are explained in the following order with reference to the attached figures.
<1. First Embodiment>
<2. Configuration Example of HMD>
<3. Configuration of Vehicle System>
<4. Positional Relation Among Sections>
<5. Calibration>
<6. Determination as to Whether or Not Execution of Calibration is Possible>
<7. Second Embodiment>
<8. Third Embodiment>
<9. Modification Examples>
<10. Summary>
<11. Present Technology>

### 1. First Embodiment

A first embodiment is explained, taking a head mounted display (hereinafter, described as an “HMD 1”) as an example of equipment that a user is wearing. The HMD 1 may be eye-glass type equipment or may be a mobile terminal apparatus such as a smartphone.

In addition, when the user has the HMD 1 on in a state where the user exists in a vehicle 100, calibration of various types of parameters is performed.

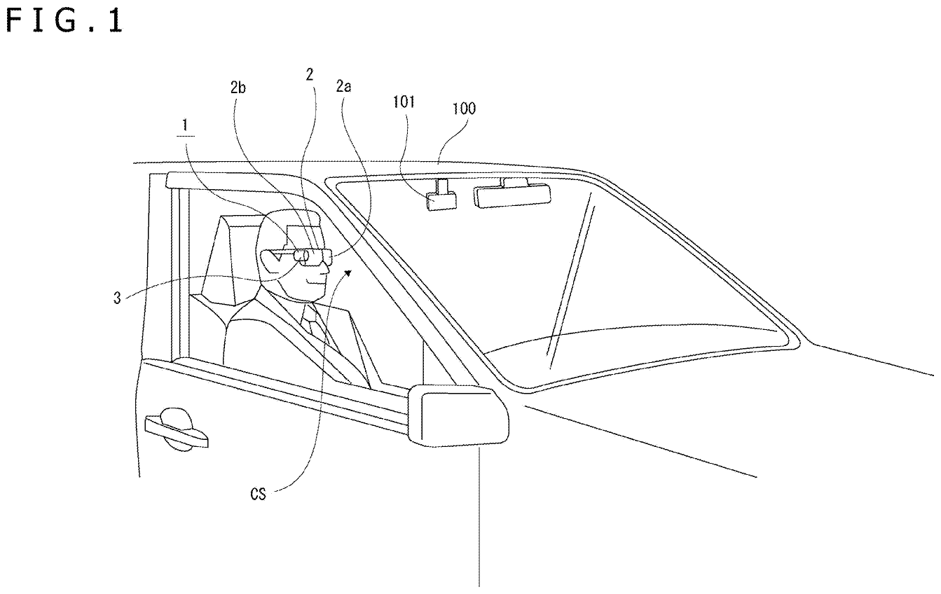

The HMD 1 includes an optical see-through type display section 2 as depicted in FIG. 1, and the user can visually recognize the real world through the display section 2. In addition, the display section 2 includes a left eye area 2a and a right eye area 2b. By displaying images for binocular parallax in the left eye area 2a and the right eye area 2b, respectively, the display section 2 can allow the user to visually recognize an augmented reality (AR: Augmented Reality) space in which a virtual object VOB is arranged at a predetermined position in the real world. Specifically, it becomes possible to superimpose an image in which the contour of a pedestrian is emphasized on a windshield of the vehicle 100 or to display navigation information on the windshield of the vehicle 100. Other than these, it is also possible to superimpose, on controllers provided to the vehicle 100, captions to explain the controllers.

The HMD 1 includes an image capturing section that can capture images of a space in front of the display section 2. The space in front of the display section 2 is the space in the line-of-sight direction of the user who has the HMD 1 on. In addition, a camera that can capture images of a driver (the user) seated on the driver's seat is installed on the dashboard, the ceiling portion, or the like of the vehicle 100.

In the following explanation, the image capturing section included in the HMD 1 is defined as a first camera 3, and the camera that is installed in the vehicle 100, and can capture images of the user is defined as a second camera 101.

Note that the user needs to be positioned in a space where the second camera 101 is arranged, in order to perform calibration mentioned later. For example, the space where the second camera 101 is arranged is the cabin space or the like of the vehicle 100 as a mobile body, and this space is described as a “target space CS.”

The HMD 1 estimates the position and the posture of itself in order to arrange a virtual object VOB at a desired position. Then, by performing the calibration mentioned later in a case where the estimated position and posture of itself are not appropriate, various types of parameters of the HMD 1 are calibrated.

Note that the estimation of the position and the posture of the HMD 1 may be estimation of the position and the posture (orientation) of the display section 2 of the HMD 1 or may be estimation of the position and the posture about another particular element belonging to the HMD 1.

The estimation of the position and the posture about the HMD 1 is performed on the basis of a first captured image G1 captured with the first camera 3 in some cases, and is performed on the basis of a second captured image G2 captured with the second camera 101 in some other cases. Here, a mode in which the estimation of the position and the posture about the HMD 1 is performed on the basis of a first captured image G1 is defined as a “first mode MD1,” and a mode in which the estimation of the position and the posture about the HMD 1 is performed on the basis of a second captured image G2 is defined as a “second mode MD2.”

In addition, estimation information regarding a position and a posture of the HMD 1 estimated on the basis of a first captured image G1 is defined as “first estimation information P1,” and estimation information regarding a position and a posture of the HMD 1 estimated on the basis of a second captured image G2 is defined as “second estimation information P2.”

While the first camera 3 is an image capturing section provided on the HMD 1 worn by the user, the second camera 101 is an image-capturing apparatus installed (fixed) in the target space CS. Because of this, it is likely that second estimation information P2 is more accurate than first estimation information P1.

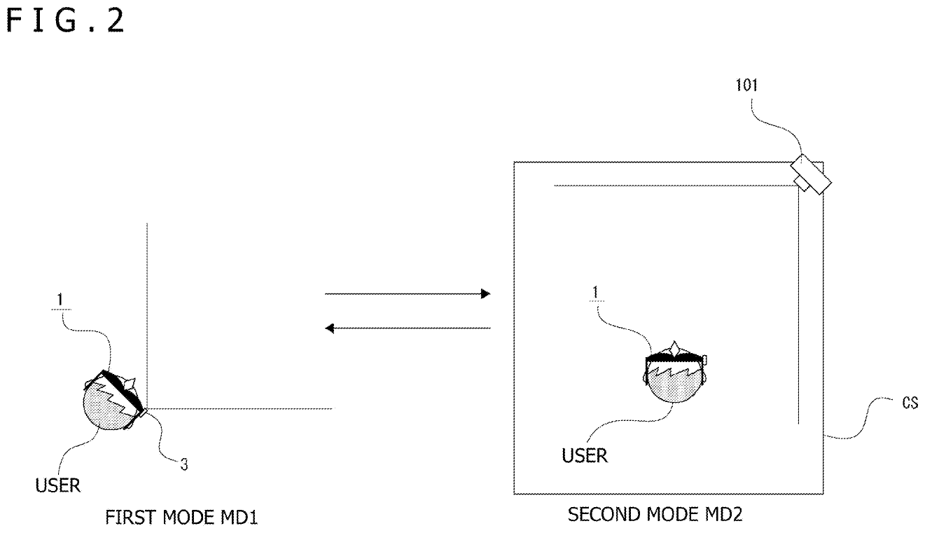

Then, the HMD 1 basically operates in the first mode MD1 in which the estimation of the position and the posture of itself is performed by using a first captured image G1, but the HMD 1 operates in the second mode MD2 in which the estimation of the position and the posture of the HMD 1 is performed by using a second captured image G2 in a case where the user has moved to the target space CS where the second camera 101 is arranged (see FIG. 2).

### 2. Configuration Example of HMD

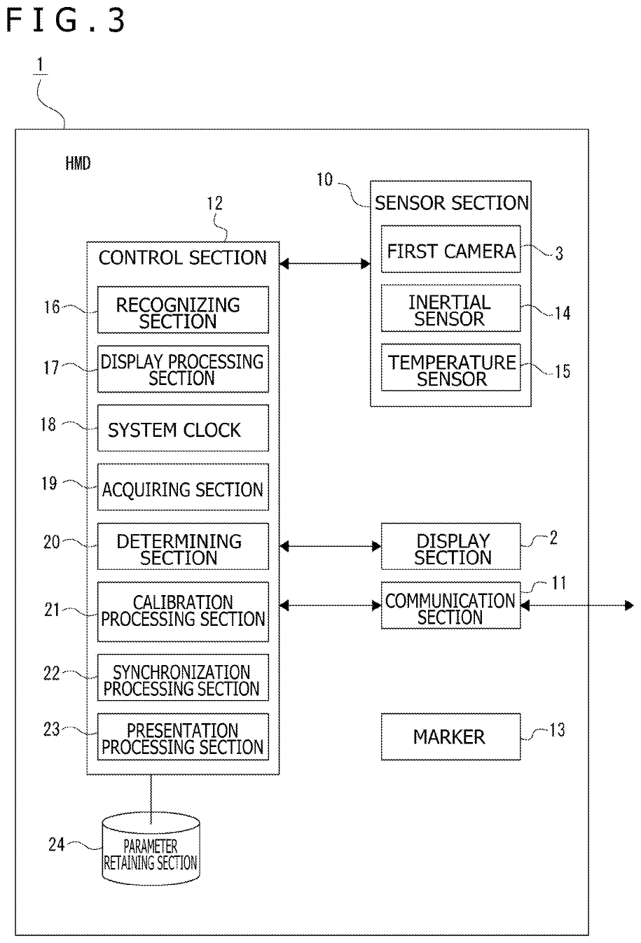

A configuration example of the HMD 1 is explained with reference to FIG. 3. As mentioned above, the HMD 1 includes the display section 2 and the first camera 3. In addition, the HMD 1 further includes a sensor section 10, a communication section 11, a control section 12, and a marker 13.

The sensor section 10 represents various types of sensors comprehensively and includes various types of sensors. For example, the first camera 3 mentioned above also is an example of sensors included in the sensor section 10.

Other than it, the sensor section 10 includes an inertial sensor 14 and a temperature sensor 15.

As the first camera 3, various types of camera apparatuses can be adopted. For example, it may be a camera that can acquire color captured images or may be an IR camera that is sensitive to IR (Infrared) light. In addition, the first camera 3 may be a camera having a distance measurement function that allows acquisition of distance images. Note that it may be a camera that combines multiple functions like a camera that can acquire both color images and distance images.

It is supposed that the inertial sensor 14 is an IMU (Inertial Measurement Unit) including an acceleration sensor, a gyro sensor, and the like. The inertial sensor 14 can be used for detecting the position and the posture of the display section 2 of the HMD 1.

The temperature sensor 15 is a sensor that measures an internal temperature of the HMD 1 or the like. Temperature data output from the temperature sensor 15 is used for calibration or selection of parameters that change depending on a temperature.

Note that the configuration of the sensor section 10 depicted in FIG. 3 is merely an example. The configuration may not include a part of the configuration depicted in FIG. 3 or may include sensors other than those included in the configuration depicted in FIG. 3.

For example, the sensor section 10 may include at least some of a sensor that can detect signals based on a GNSS (Global Navigation Satellite System), a distance measurement sensor other than the first camera 3 and an ultrasonic sensor.

The communication section 11 performs a process of transmitting/receiving information necessary for the HMD 1 to realize various types of processes mentioned later. For example, it transmits time information to a control section of the second camera 101 in order to synchronize the first camera 3 and the second camera 101. At this time, the communication section 11 may transmit information to the control section of the second camera 101 via a communication section of the vehicle 100.

The communication section 11 receives second estimation information P2 from the second camera 101 or a vehicle system S that controls the vehicle 100.

Note that the communication section 11 may use wireless communication or may use wired communication.

The control section 12 has a function to perform various types of processes. For example, as depicted in FIG. 3, the control section 12 includes a recognizing section 16, a display processing section 17, a system clock 18, an acquiring section 19, a determining section 20, a calibration processing section 21, a synchronization processing section 22, and a presentation processing section 23.

The recognizing section 16 performs a process of estimating the position and the posture about the HMD 1 itself by using output signals from various types of sensors included in the sensor section 10, a process of creating an environmental map (SLAM: Simultaneous Localization and Mapping), that is, generating first estimation information P1, a process of detecting real objects ROB positioned nearby, and the like. For example, the real objects ROB are objects that exist really such as controllers such as the steering wheel or buttons or pedestrians positioned outside the vehicle, if the vehicle is being driven.

Note that the detection of the real objects ROB may be performed by detecting markers provided on the real objects ROB.

The detection of the real objects ROB by the recognizing section 16 may be performed by using depth information estimated from stereo images, may be performed by pattern matching using color captured images or may be performed by using machine learning (e.g., deep learning, etc.) using training data.

It is attempted to enhance the precision of first estimation information P1 generated by the recognizing section 16 or results of recognition of the positions and postures of the recognized real objects ROB by taking into consideration temperature characteristics of various types of data such as parameters used for the estimation. Accordingly, the recognizing section 16 is configured to be capable of acquiring parameters that vary depending on a temperature from a parameter retaining section 24.

The data that varies depending on a temperature is, for example, a parameter used for distortion calibration of a lens in the first camera 3, data output from the IMU, and the like. The recognizing section 16 may use a CPU (Central Processing Unit) or a GPU (Graphics Processing Unit) in the process of estimating the position and the posture of itself, the creation of the environmental map or the detection of the real objects ROB, and, in a case where machine learning is used, may use a TPU (Tensor Processing Unit).

The display processing section 17 performs a process of generating drawing data for drawing a virtual object VOB on the basis of estimation information regarding the position and the posture of itself output from the recognizing section 16, and outputs the drawing data to the display section 2. Specifically, the display processing section 17 generates drawing data to be displayed in the left eye area 2a included in the display section 2, and drawing data to be displayed in the right eye area 2b included in the display section 2. These types of drawing data are for allowing the virtual object VOB arranged at a predetermined position in a three-dimensional space to be visually recognized, by using binocular parallax.

The display section 2 performs a display process based on the drawing data output from the display processing section 17. Thereby, a virtual object VOB is displayed on the display section 2. The user who has the HMD 1 on can visually recognize, via the display section 2, real objects ROB on which the virtual object VOB is superimposed, and the like.

Note that the display processing section 17 is configured to be capable of executing both a first display process of causing a virtual object VOB to be displayed on the basis of first estimation information P1, and a second display process of causing a virtual object VOB to be displayed on the basis of second estimation information P2.

Various types of display such as an LCD (Liquid Crystal Display) or an organic EL (Electro Luminescence) can be applied as the display section 2.

The system clock 18 measures elapsed time since the system of the HMD 1 is activated.

The acquiring section 19 performs a process of acquiring first estimation information P1 from the recognizing section 16, and a process of acquiring second estimation information P2 from the vehicle system S or the second camera 101. Note that the second estimation information P2 may be generated by the recognizing section 16 that has received the second captured image G2, and, in that case, acquires the second estimation information P2 from the recognizing section 16.

The determining section 20 executes a process of comparing first estimation information P1 and second estimation information P2, and determining which estimation information has higher accuracy, a process of determining whether or not to execute calibration for increasing the accuracy of first estimation information P1, a process of determining whether or not to execute calibration for increasing the accuracy of second estimation information P2, and the like.

Results of the determination as to whether or not to execute calibration are output to the calibration processing section 21. For example, the determination results mentioned here are flag information representing that calibration for increasing the accuracy of first estimation information P1 is to be or is not to be executed, flag information representing that calibration for increasing the accuracy of second estimation information P2 is to be or is not to be executed, and the like. Furthermore, information for identifying calibration-target parameters may be included in the determination results.

The calibration processing section 21 performs calibration on the basis of results of the determination as to whether or not to execute calibration. In the calibration, calibration of parameters themselves used for derivation of first estimation information P1 and second estimation information P2 may be performed, or a transformation matrix about the position and the posture for making first estimation information P1 closer to a true value may be determined.

Note that, in a case where calibration of parameters themselves used for derivation of second estimation information P2 is to be performed, the calibration processing section 21 may generate a command or the like for causing the vehicle system S or the second camera 101 to execute the calibration, and give the instruction via the communication section 11.

There are various types of calibration-target parameter. For example, parameters used for derivation of first estimation information P1 include internal parameters such as the optical-axis direction, focal length or distortion of the first camera 3, external parameters for identifying a positional relation between the first camera 3 and the display section 2, and the like. These parameters, that is, the parameters used for derivation of first estimation information P1, are collectively described as “first parameters.”

In addition, parameters used for derivation of second estimation information P2 include parameters such as the optical-axis direction, focal length or distortion of the second camera 101. Note that the parameters used for derivation of second estimation information P2 may include parameters for identifying a positional relation between the second camera 101 and a predetermined component (the steering wheel, etc.) fixed inside the vehicle.

These parameters, that is, the parameters used for derivation of second estimation information P2, are collectively described as “second parameters.”

The calibration-target first parameters are stored on the parameter retaining section 24.

The synchronization processing section 22 performs a process for synchronizing the first camera 3 and the second camera 101. Note that the first camera 3 and the second camera 101 may not perform image-capturing at completely the same timing. For example, in one possible manner of configuration, delays of communication performed by the first camera 3 and the second camera 101 may be identified such that a second captured image G2 captured at substantially the same timing as a first captured image G1 captured with the first camera 3 can be identified.

The presentation processing section 23 performs a process for presenting choices or the like to the user. As mentioned later, in some cases, the user is asked to select one which is arranged at a more appropriate position from a virtual object VOB generated on the basis of first estimation information P1 or a virtual object VOB generated on the basis of second estimation information P2. In that case, the presentation processing section 23 presents choices for allowing selection of either one via the display section 2.

The control section 12 includes a microcomputer having a computation processing section such as a CPU and a storage section such as a ROM or a RAM, and realizes various types of functions mentioned above by executing various types of processes in accordance with programs stored on the ROM. Note that some or all of the various types of function mentioned above may be realized by hardware.

The marker 13 is a sign provided at a predetermined element of the HMD 1, and is used for estimation of the position and the posture of the HMD 1 by being captured in a second captured image G2 captured with the second camera 101.

For example, second estimation information P2, which is a result of estimation of the position and the posture of the HMD 1, is generated by detecting a captured shape and size of the marker 13 in a second captured image G2.

Note that multiple markers 13 may be provided, and, in that case, it is possible to attempt to realize higher precision of second estimation information P2. In addition, a dedicated element having only the function of the marker 13 may not be provided. For example, a corner or the like belonging to the display section 2 may function as the marker 13. That is, second estimation information P2, which is a result of estimation of the position and the posture of the display section 2, may be generated by identifying a predetermined element of the display section 2 from a second captured image G2 captured with the second camera 101.

### 3. Configuration of Vehicle System

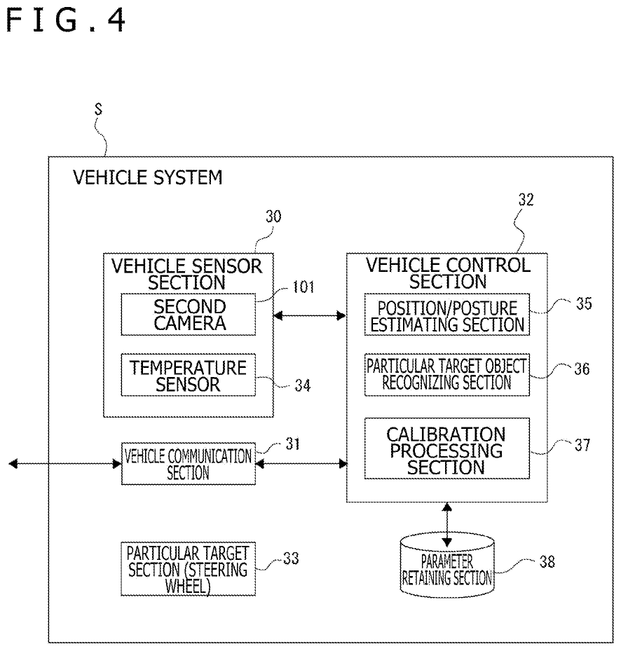

A configuration example of the vehicle system S is explained with reference to FIG. 4.

The vehicle system S includes a vehicle sensor section 30, a vehicle communication section 31, a vehicle control section 32, and a particular target section 33.

The vehicle sensor section 30 includes various types of sensors. FIG. 4 representatively depicts sensors to be used for calculating second estimation information P2, which is a result of estimation of the position and the posture of the HMD 1.

The vehicle sensor section 30 includes the second camera 101 and a temperature sensor 34.

As the second camera 101, various types of camera apparatuses can be adopted. For example, a camera that can acquire color captured images, an IR camera, or the like can be adopted as the second camera 101.

The temperature sensor 34 is a sensor that can measure an internal temperature of the second camera 101. Temperature data acquired here is used for selection of parameters of the second camera 101 or the like.

The vehicle sensor section 30 may include a distance measurement sensor, an ultrasonic sensor, or the like, in addition to the second camera 101 and the temperature sensor 34.

The vehicle communication section 31 performs processes of transmitting/receiving information related to generation of second estimation information P2.

Specifically, the vehicle communication section 31 performs a process of transmitting generated second estimation information P2 to the HMD 1, a process of receiving information which is an instruction as to whether or not to perform calibration targeted at second parameters used for calculation of second estimation information P2, and the like.

The vehicle control section 32 performs comprehensive control of the vehicle 100, and also performs various types of processes related to generation of second estimation information P2. In addition, it performs calibration for enhancing the accuracy of second estimation information P2.

The vehicle control section 32 includes a position/posture estimating section 35, a particular target object recognizing section 36, and a calibration processing section 37.

The position/posture estimating section 35 estimates the position and the posture of the HMD 1 or estimates the position and the posture of the display section 2, and generates second estimation information P2.

The particular target object recognizing section 36 performs a process of recognizing a particular target object belonging to the vehicle 100. As long as it belongs to the vehicle 100, it may be one not incorporated into the vehicle system S. In the example depicted in FIG. 4, a steering wheel H as a steering apparatus incorporated into the vehicle system S is defined as the particular target object.

The calibration processing section 37 calibrates second parameters to be used for estimating second estimation information P2. For example, internal parameters such as the optical-axis direction, focal length or distortion of the second camera 101, or the like can be the calibration target.

The calibration is performed depending on how an image of the steering wheel H as the particular target object is captured in a second captured image G2 captured with the second camera 101. For example, in a case where there is a positional deviation between an image capturing area of the steering wheel H in a previously-captured second captured image G2 and an image capturing area of the steering wheel H in the latest second captured image G2, the calibration of second parameters mentioned above is performed. Note that, as mentioned before, the calibration processing section 37 may calibrate second parameters on the basis of a command received from the calibration processing section 21 of the HMD 1.

The particular target section 33 is an imaging-subject object used for calibration like the steering wheel H mentioned before.

A parameter retaining section 38 has stored thereon calibration-target second parameters.

### 4. Positional Relation Among Sections

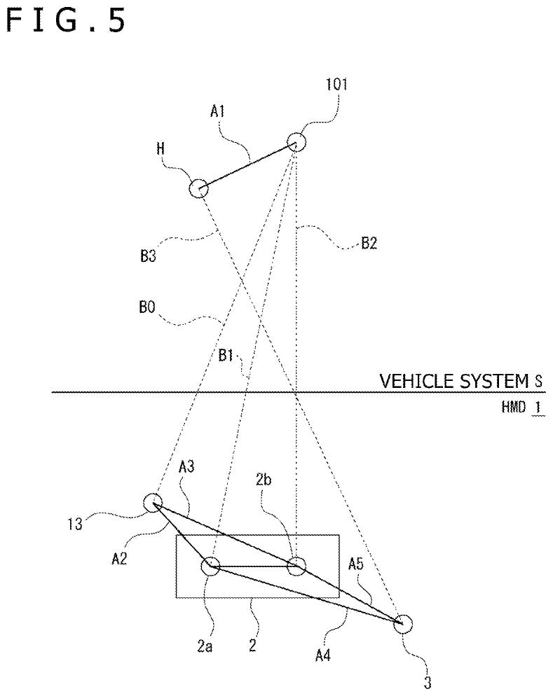

The positional relation among sections of the HMD 1 and sections of the vehicle system S is explained with reference to FIG. 5.

Note that solid lines depicted in the figure represent the positional relation identified at the last calibration. In addition, broken lines depicted in the figure represent the positional relation that is variable depending on measurement.

First, a positional relation between the second camera 101 and the steering wheel H as the particular target object in the vehicle system S is known already due to the preliminary calibration. Stated differently, a transformation matrix A1 for transformation from the coordinate position (hereinafter, described simply as the “position”) of the steering wheel H to the position of the second camera 101 is known already.

Similarly, the positional relation among the left eye area 2a and right eye area 2b of the display section 2, the first camera 3 and the marker 13 in the HMD 1 also is known already due to the preliminary calibration. That is, a transformation matrix A2 for transformation from the position of the marker 13 to the position of the left eye area 2a, and a transformation matrix A3 for transformation from the position of the marker 13 to the position of the right eye area 2b are known already. In addition, similarly, a transformation matrix A4 for transformation from the position of the first camera 3 to the position of the left eye area 2a, and a transformation matrix A5 for transformation from the position of the first camera 3 to the position of the right eye area 2b are known already.

On the other hand, a positional relation between the first camera 3 and the steering wheel H, and a positional relation between the second camera 101 and the left eye area 2a and right eye area 2b change from moment to moment.

By identifying these changing positional relations, a position and a posture of the display section 2 at each moment can be estimated.

By performing image processing on a second captured image G2 captured with the second camera 101, the position, orientation, and the like of the marker 13 are recognized, and, on the basis of results of the recognition, a position and a posture of the display section 2 in the target space CS are estimated.

Specifically, a transformation matrix B1 for transformation from the position of the second camera 101 to the position of the left eye area 2a is obtained by multiplying a transformation matrix B0 for transformation from the position of the second camera 101 to the position of the marker 13 by the transformation matrix A2 mentioned earlier.

Similarly, a transformation matrix B2 for transformation from the position of the second camera 101 to the position of the right eye area 2b is obtained by multiplying the transformation matrix B0 for transformation from the position of the second camera 101 to the position of the marker 13 by the transformation matrix A3 mentioned earlier.

Accordingly, the transformation matrices for transformation from the position of the steering wheel H to the positions of the left eye area 2a and right eye area 2b are obtained by multiplying the transformation matrix A1 mentioned earlier by the transformation matrix B1 and the transformation matrix B2, respectively.

The thus-estimated transformation matrix for transformation from the position of the steering wheel H to the position of the left eye area 2a, and transformation matrix for transformation from the position of the steering wheel H to the position of the right eye area 2b are second estimation information P2.

First estimation information P1 also is explained similarly.

By performing an image analysis process on a first captured image G1 captured with the first camera 3, the position and the posture of the steering wheel H are identified. Thereby, a transformation matrix B3 for transformation from the position of the first camera 3 to the position of the steering wheel H is calculated.

Transformation matrices for transformation from the position of the steering wheel H to the positions of the left eye area 2a and right eye area 2b can be calculated by multiplying the inverse matrix of the transformation matrix B3 by the transformation matrix A4 and transformation matrix A5 mentioned earlier, respectively.

The thus-calculated transformation matrices for transformation from the position of the steering wheel H to the positions of the left eye area 2a and right eye area 2b are first estimation information P1.

### 5. Calibration

The calibration processing section 21 performs calibration by using a difference between first estimation information P1 and second estimation information P2. As processing content of the calibration, as mentioned before, calibration of the first parameters or second parameters themselves used for derivation of first estimation information P1 and second estimation information P2 may be performed, or a transformation matrix about the position and the posture for making first estimation information P1 closer to a true value may be determined.

Hereinbelow, a specific procedure for determining transformation matrices is explained.

In the following case considered, for example, a virtual object VOB is superimposed on the steering wheel H arranged at a predetermined position and posture in the target space CS. The following (Formula 1) is used for computing one point in a two-dimensional screen coordinate system of the left eye area 2a in the display section 2 corresponding to a certain one point of the virtual object VOB in a three-dimensional space.

Pos=P·V·Pose (Formula 1)

Here, Pose in (Formula 1) represents the position and the posture of the steering wheel H in a three-dimensional World coordinate system. Specifically, Pose is an x coordinate, a y coordinate, and a z coordinate representing the position, and a rotation matrix, a quaternion (quaternion), or the like representing the posture.

V in (Formula 1) is a transformation matrix for transformation from the World coordinate system to a camera coordinate system of the first camera 3. The transformation matrix V represents the position and the posture of the steering wheel H as seen from the first camera 3, and is based on first estimation information P1.

P in (Formula 1) is a transformation matrix for transformation from the camera coordinate system to the screen coordinate system of the left eye area 2a. The transformation matrix P is based on a positional relation between the first camera 3 and the left eye area 2a.

Pos in (Formula 1) represents the pixel position in the screen coordinate system of the left eye area 2a.

If the first estimation information P1 is correct, the user can visually recognize a state where the virtual object VOB is accurately superimposed on the steering wheel H by displaying the virtual object VOB at coordinates in the screen coordinate system calculated according to (Formula 1).

However, a deviation of the first estimation information P1 from a correct value occurs undesirably due to various types of factors as mentioned above.

In a case where a deviation occurs, Pos as the arrangement position of the virtual object VOB in the screen coordinate system of the left eye area 2a can be calibrated by calculating a transformation matrix V′ for performing calibration on the basis of second estimation information P2.

Specifically, Pos is calibrated by using the following (Formula 2).

Pos=P·V′·V·Pose (Formula 2)

Here, Pose, V, and P are variables similar to those in (Formula 1), and explanations thereof are omitted.

V′ is defined as a transformation matrix for transforming information regarding a position and a posture as the first estimation information P1 estimated on the basis of a first captured image G1 into information regarding a position and a posture as the second estimation information P2 estimated on the basis of a second captured image G2.

That is, V′ in (Formula 2) is defined as a determinant for eliminating an error of the first estimation information P1, and making the first estimation information P1 closer to a true value, on the premise that the second estimation information P2 is correct.

Whether to calculate the position in the screen coordinate system by using (Formula 2) using V′ or to calculate the position in the screen coordinate system by using (Formula 1) not using V′ is decided on the basis of the magnitude of the error of the first estimation information P1, the use or function of a virtual object VOB, the types of real objects ROB on which the virtual object VOB is superimposed, or the like.

For example, it is sufficient if (Formula 1) is used when the difference between the first estimation information P1 and the second estimation information P2 is so small. Since it is not necessary to calculate the transformation matrix V′ in this case, it is possible to attempt to mitigate the processing load.

Alternatively, in a case where, although the difference between the first estimation information P1 and the second estimation information P2 is great to some extent, the use of a virtual object VOB is to display navigation information to the user or a case where information is displayed independently of particular real objects ROB or in other cases, (Formula 1) may be used even if the first estimation information P1 includes the error.

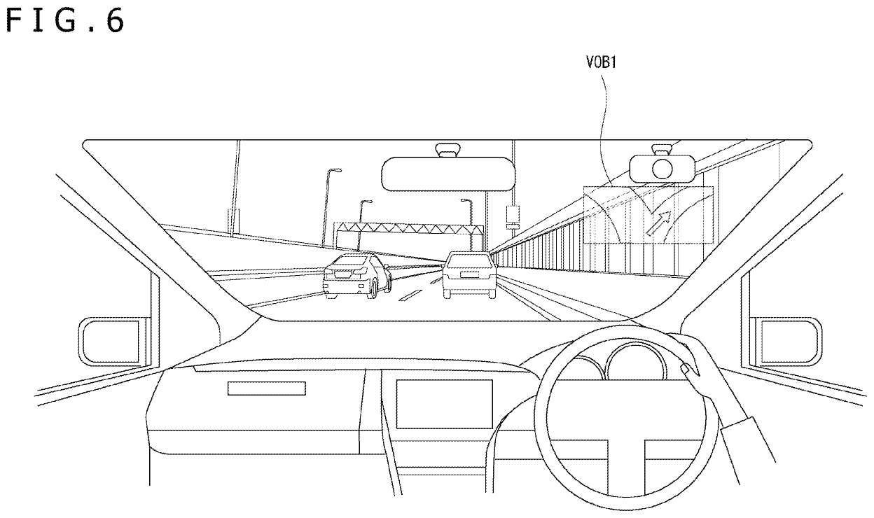

Specifically, in a case where a virtual object VOB1 as navigation information is displayed on the windshield of the vehicle 100 as depicted in FIG. 6, it is estimated that there will be no problems for the user even if the display position is several centimeters out of place. Accordingly, the display position (i.e., the x coordinate and y coordinate in the screen coordinate system) of the virtual object VOB1 as navigation information is decided by using (Formula 1).

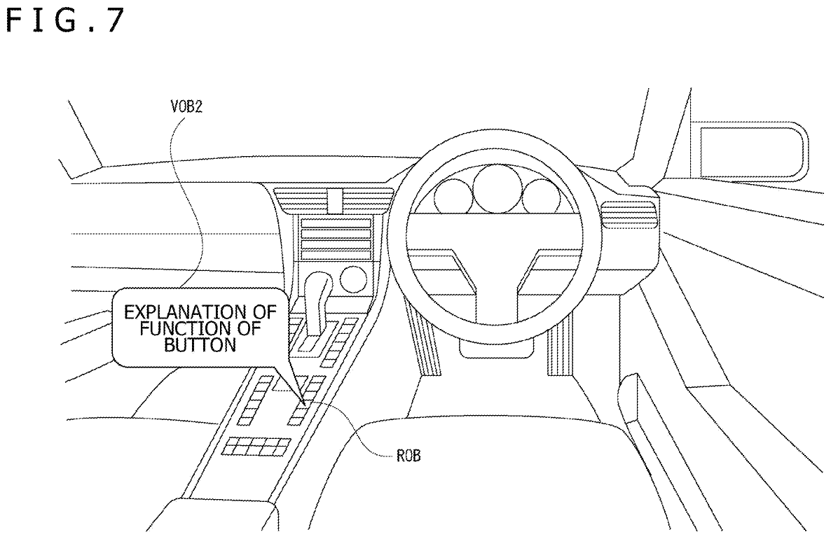

On the other hand, in a case where a virtual object VOB2 as a function explanation about various types of controllers such as buttons arranged on a dashboard or steering wheel of the vehicle 100 is displayed as depicted in FIG. 7, it is necessary to superimpose the virtual object VOB2 accurately on a real object ROB as a button to be explained. Accordingly, the display position of the virtual object VOB2 is decided by using second estimation information which is information that represents the accurately-estimated position and posture of the left eye area 2a of the display section 2.

Thereby, undesirable presentation of a wrong function explanation to the user is prevented.

### 6. Determination as to Whether or Not Execution of Calibration is Possible

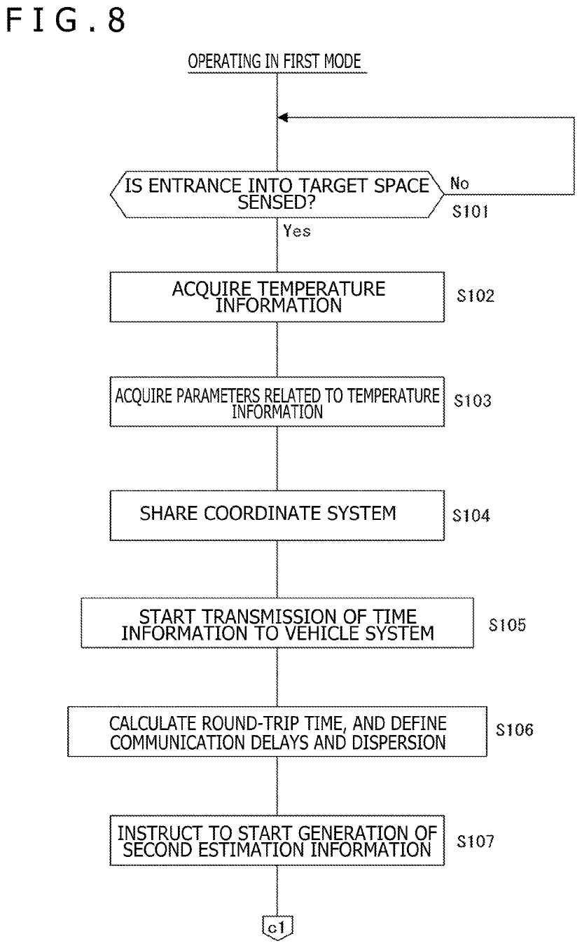

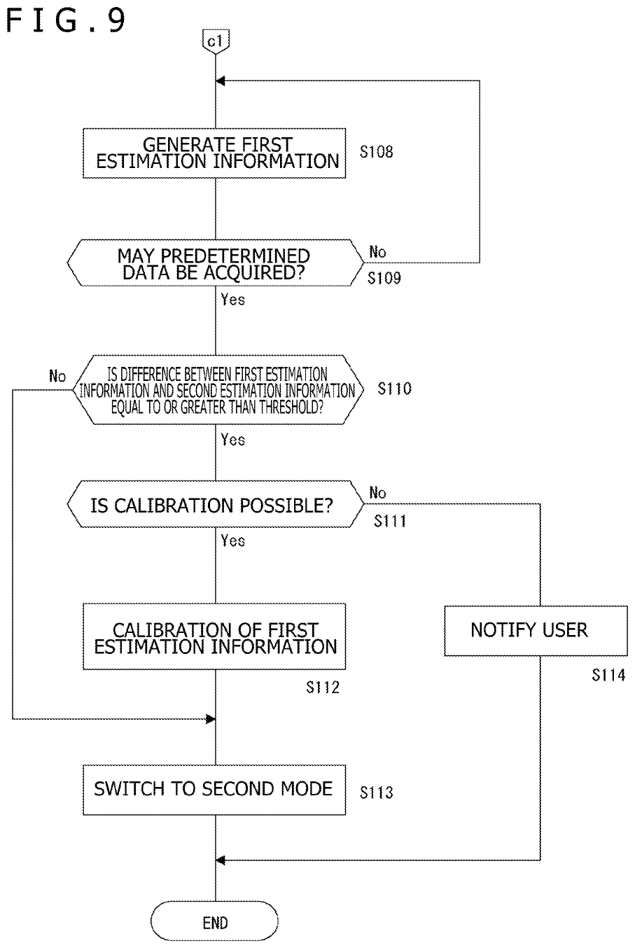

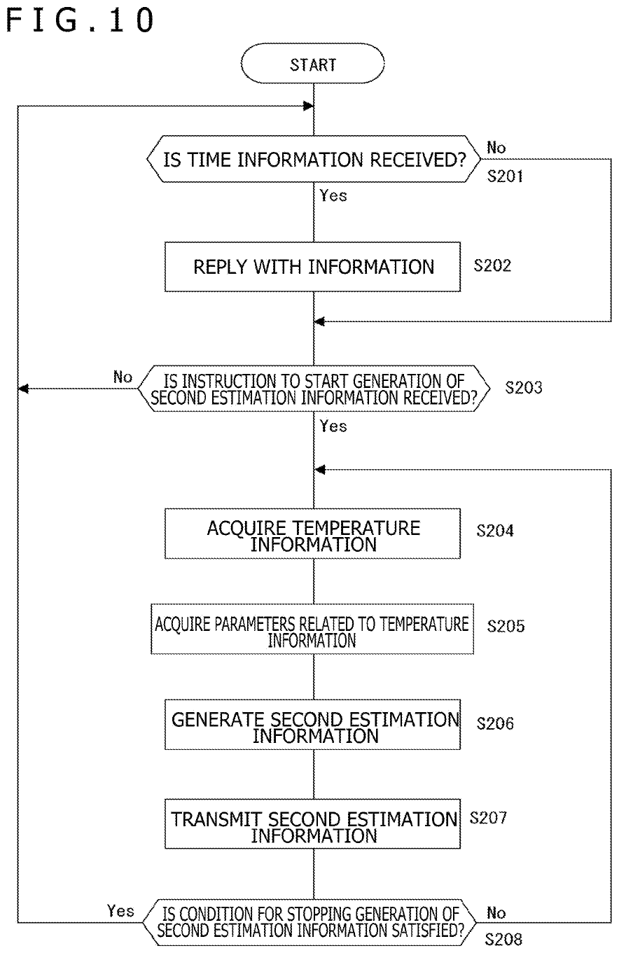

A flowchart about a process to be executed by the control section 12 of the HMD 1, and a flowchart about a process to be executed by the vehicle system S for determining whether or not calibration should be executed are depicted in FIG. 8 and FIG. 9, and in FIG. 10, respectively.

First, as a premise, the flowchart depicted in FIG. 8 and FIG. 9 is a flowchart started in a state before the user gets in the vehicle 100. Note that the connection between procedures in the figures is represented by “c1.”

At Step S101 in FIG. 8, the control section 12 of the HMD 1 determines whether or not entrance into the cabin space as the target space CS where the second camera 101 is fixedly arranged is sensed. For example, the sensing of entrance into the target space CS may be sensing based on a result of image processing on a first captured image G1 or may be detection based on information reception from the vehicle system S.

In a case where it is determined at Step S101 that entrance is not sensed, the control section 12 executes the process at Step S101 again.

On the other hand, in a case where it is determined at Step S101 that entrance is sensed, at Step S102, the control section 12 acquires, from the temperature sensor 15, information regarding the internal temperature of the HMD 1.

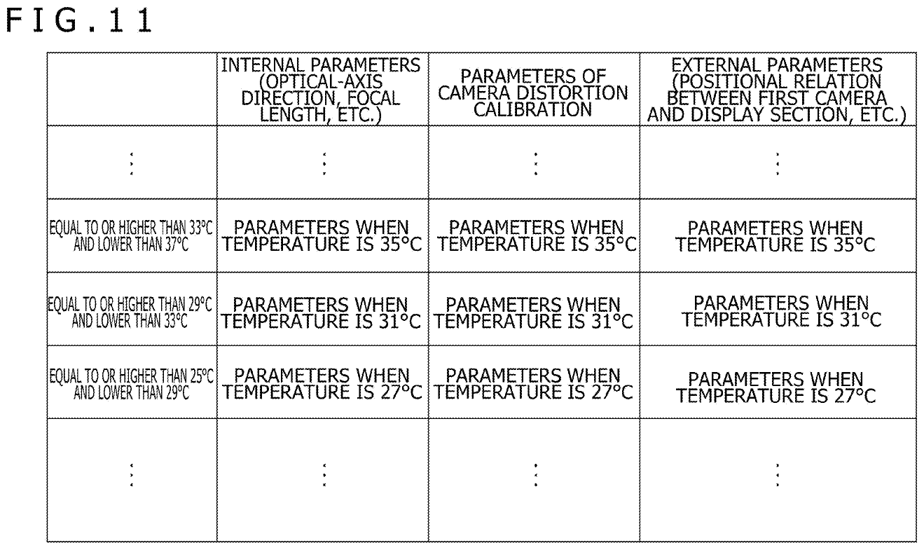

At Step S103, the control section 12 acquires, from the parameter retaining section 24, various types of parameters information on the basis of the internal temperature information regarding the HMD 1. The parameters acquired here are the first parameters that are necessary for generation of the first estimation information, and change depending on a temperature. For example, as depicted in FIG. 11, the value of each parameter is stored for each predetermined temperature range, and corresponding parameters are acquired from the parameter retaining section 24 on the basis of the temperature information acquired from the temperature sensor 15.

At Step S104, the control section 12 shares the World coordinate system. For example, by setting the X axis, the Y axis, and the Z axis relative to, as the origin, the position of the steering wheel H as the particular target object, the World coordinate system is shared.

At Step S105, the control section 12 starts transmission of time information to the vehicle system S. Specifically, information regarding the elapsed time since the system has been activated that is measured by the system clock 18 is transmitted to the vehicle system S.

As mentioned later, upon receiving the elapsed time information from the HMD 1, the vehicle control section 32 of the vehicle system S transmits (sends back) some information to the HMD 1. Here, the information to be sent back may be such information as an ACK (Acknowledgement) representing that the elapsed time information has been received or may be the time information received from the HMD 1. In the following case explained, the received time information is returned to the HMD 1.

At Step S106, the control section 12 calculates a length of time required for data transmission/reception between the HMD 1 and the vehicle system S to make a round trip, and defines communication delays and dispersion. For example, data transmission at Step S105 is performed multiple times and also reception of data sent back along with the data transmission is performed the same number of times. Then, the difference between the time of transmission and the time of reception of each piece of data is calculated, and the average of the differences is calculated to thereby define communication delays. In addition, the dispersion of communication delays is defined by calculating the variance or the like of the differences.

Note that, by the vehicle system S sending back to the HMD 1 the received time information as it is, the HMD 1 can estimate round-trip time on the basis of the difference between time information stored in the received information (i.e., time information transmitted to the vehicle system S) before and the reception time.

At Step S107, the control section 12 transmits, to the vehicle system S, an instruction (command) to start generation of second estimation information P2. Thereby, generation of the second estimation information P2 using a second captured image G2 is performed at the vehicle system S.

The second estimation information P2 generated at the vehicle system S is associated with the time information received from the HMD 1, and transmitted to the HMD 1 as appropriate. The time information associated with the second estimation information P2 here is time information closest to the image-capturing time of the second captured image G2 used for generation of the second estimation information P2. Accordingly, on the basis of the time information received along with the second estimation information P2, the control section 12 can obtain the image-capturing time of the second captured image G2 used for the generation of the second estimation information P2.

At Step S108 in FIG. 9, the control section 12 generates first estimation information P1 by using a first captured image G1. The first estimation information P1 generated here is estimated on the basis of the first captured image G1 captured at substantially the same time as the second captured image G2 used for the estimation of the second estimation information P2.

In the following explanation, first estimation information P1 and second estimation information P2 that are generated on the basis of a first captured image G1 and a second captured image G2 that are captured substantially the same times are described as “corresponding estimation information.”

Note that substantially the same time may be completely the same time as the second captured image G2 used for generation of the second estimation information P2 or may be a time whose difference from the time at which the second captured image G2 is captured is smaller than a predetermined threshold such as several milliseconds or several dozen milliseconds.

At Step S109, the control section 12 determines whether or not predetermined data may be acquired. The predetermined data mentioned here means at least a set of first estimation information P1 and second estimation information P2, and is the first estimation information P1 and the second estimation information P2 as corresponding estimation information.

In addition, the number of sets of first estimation information P1 and second estimation information P2 may be one, but it may be determined at Step S109 whether or not multiple sets of first estimation information P1 and the second estimation information P2 may be acquired in order to perform calibration more highly precisely.

For example, the result of the determination at Step S109 may be “Yes” in a case where not only one set of first estimation information P1 and second estimation information P2 estimated about the HMD 1 determined as being at a certain position and posture, but also another set of first estimation information P1 and second estimation information P2 estimated about the HMD 1 determined as being at a different position and posture at another timing may be acquired.

It becomes possible to perform highly-precise calibration by comparing first estimation information P1 and second estimation information P2 about multiple positions and postures.

Note that the predetermined data may be three or more sets of estimation information.

In a case where the control section 12 determined at Step S109 that the predetermined data may not be acquired, the control section 12 generates first estimation information P1 at Step S108 again. The first estimation information P1 generated here is estimation information corresponding to new second estimation information P2 received from the vehicle system S.

The process at Step S108 is executed repeatedly until the predetermined data can be acquired.

On the other hand, in a case where it is determined at Step S109 that the predetermined data may be acquired, the control section 12 proceeds to Step S110, and determines whether or not the difference between the first estimation information P1 and the second estimation information P2 is equal to or greater than a threshold. For example, if information (first estimation information P1) about a position and a posture about the HMD 1 estimated on the basis of the first captured image G1 and information (second estimation information P2) about a position and a posture about the HMD 1 estimated on the basis of the second captured image G2 are completely the same, it is determined that the difference is smaller than the threshold.

On the other hand, in a case where the estimated positions and postures are significantly different, it is determined that the difference is equal to or greater than the threshold.

Note that, in a case where multiple sets of estimation information may be acquired, at Step S110, the threshold and the average of differences in the respective sets may be compared, the threshold and the greatest difference may be compared or the threshold and the smallest difference may be compared. In a case where the threshold and the greatest difference are compared, this is equivalent to checking whether the differences in all the sets are smaller than the threshold.

In a case where it is determined that the difference is equal to or greater than the threshold, at Step S111, the control section 12 determines whether or not calibration is possible. For example, in a case where calibration is performed by recalculating internal parameters or external parameters stored on the parameter retaining section 24, it is necessary to set each parameter to a value outside its expressible range, in some cases. In such a case, it is determined that calibration is impossible.

In a case where it is determined that calibration is possible, at Step S112, the control section 12 calibrates the first estimation information P1. For example, the calibration of the first estimation information P1 may be calibration of first parameters used for derivation of the first estimation information P1 or may be determination of a transformation matrix for making information regarding the position and the posture about the display section 2 calculated as the first estimation information P1 closer to a true value.

Next, at Step S113, the control section 12 switches to the second mode MD2. Since the second mode MD2 is for estimating the position and the posture about the HMD 1 by using the second camera 101 fixedly arranged in the target space CS as the cabin space, it is considered that the second mode MD2 attains higher estimation precision. Accordingly, by switching to the second mode MD2, it is possible to perform highly-precise superimposition-display of the virtual object VOB.

On the other hand, in a case where it is determined that calibration is impossible, at Step S114, the control section 12 performs user notification of notifying the user that calibration is not possible. The user notification may be performed by using a virtual object VOB or may be performed by a vibration or a sound.

After the process at Step S114 is ended, the control section 12 ends the series of processing depicted in FIG. 8 and FIG. 9. Note that the process of switching to the second mode MD2 at Step S113 may be performed after the process at Step S114 is ended.

An example of processes executed by the vehicle control section 32 of the vehicle system S while the control section 12 of the HMD 1 executes the processes depicted in FIG. 8 and FIG. 9 is depicted in FIG. 10.

At Step S201, the vehicle control section 32 determines whether or not time information transmitted from the control section 12 is received. This time information is the time information transmitted at Step S105 in FIG. 8. In a case where it is determined that the time information is received, at Step S202, the vehicle control section 32 performs a process of sending back information.

Note that, in a case where a regular process of transmitting time information is started at Step S105, the vehicle control section 32 executes the processes at Step S201 and Step S202 at predetermined time intervals. Then, in that case, the processes at Step S201 and Step S202 may be executed in parallel with execution of processes at and after Step S203.

At Step S203, the vehicle control section 32 determines whether or not the instruction to start generation of second estimation information P2 is received. The instruction is the instruction transmitted from the control section 12 at Step S107 in FIG. 8.

In a case where it is determined that an instruction to start generation of second estimation information P2 is not received, the vehicle control section 32 returns to the process at Step S201.

On the other hand, in a case where it is determined that an instruction to start generation of second estimation information P2 is received, the vehicle control section 32 proceeds to Step S204, and performs acquisition of temperature information output from the temperature sensor 34.

Next, at Step S205, the vehicle control section 32 performs acquisition of parameters related to temperature information. Whereas FIG. 11 depicts an example in which various types of parameters about the first camera 3 are stored for each predetermined temperature range, similar information regarding various types of parameters about the second camera 101 also are stored on the parameter retaining section 38. At Step S205, parameters appropriate for the second camera 101 are acquired according to a temperature condition.

At Step S206, the vehicle control section 32 generates second estimation information P2. Next, at Step S207, the vehicle control section 32 performs a process of transmitting the generated second estimation information P2 to the HMD 1.

Next, at Step S208, the vehicle control section 32 determines whether or not a condition for stopping generation of second estimation information P2 is satisfied.

For example, the condition for stopping generation of second estimation information P2 is that a generation/presentation instruction is received from the control section 12 of the HMD 1, that the HMD 1 that the user wearing has undesirably moved out of the angle of view of the second camera 101, that the engine of the vehicle 100 is stopped, and so on.

In a case where the condition for stopping generation of second estimation information P2 is satisfied, the vehicle control section 32 returns to the process at Step S201.

On the other hand, in a case where the condition for stopping generation of second estimation information P2 is not satisfied, the vehicle control section 32 returns to Step S204 in order to perform generation of second estimation information P2 again.

Thereby, second estimation information P2 is generated one after another, and transmitted to the HMD 1.

Note that, in a case where second estimation information P2 is generated every several dozen milliseconds or several hundred milliseconds, the process at Step S204 may not be performed every time. The process at Step S204 is a process of acquiring temperature information, and it is difficult to consider that the temperature changes suddenly in a short time such as several hundred milliseconds. Accordingly, the process at Step S204 may be executed every several seconds or every several minutes, and the process at Step S204 may be skipped at other timings.

In addition, whereas it is determined at Step S208 whether or not an instruction to stop generation of second estimation information P2 is received from the HMD 1 in the example explained, an instruction to generate second estimation information P2 may be given from the HMD 1 every time as necessary. In that case, at Step S208, it is sufficient if a determination process according to whether or not it is detected that the HMD 1 has moved out of the angle of view, the engine is stopped, and so on is performed.

### 7. Second Embodiment

In the example explained in the first embodiment, it is supposed that second estimation information P2 is basically correct information, and calibration is performed for making first estimation information P1 closer to a true value on the basis of the second estimation information P2.

In a second embodiment, calibration is executed for making second estimation information P2 closer to a true value in a case where it is determined that the second estimation information P2 is not correct.

Explanations of configuration and processes in the second embodiment that are similar to those in the first embodiment are omitted as appropriate.

Since the configuration of the HMD 1 and the vehicle system S is similar to that in the first embodiment, explanations thereof are omitted.

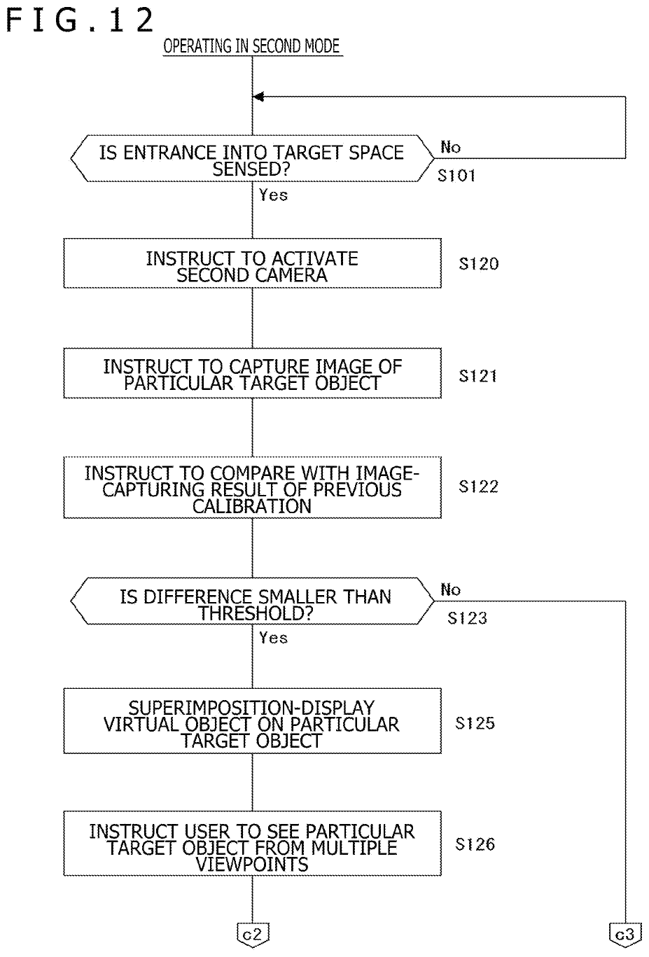

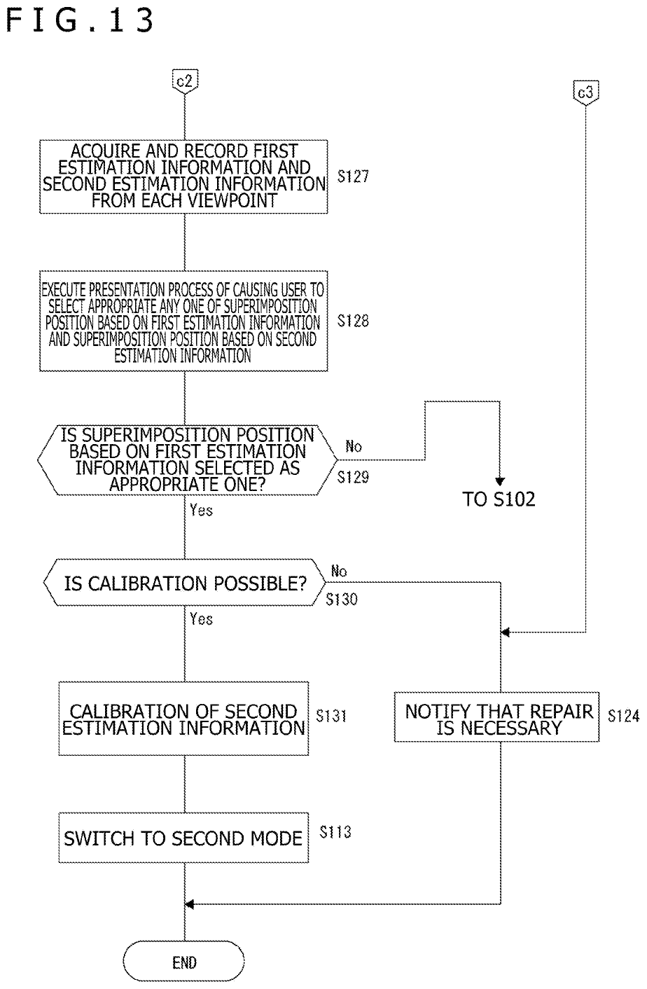

Various types of processes to be executed by the control section 12 of the HMD 1 when it is determined whether or not execution of calibration is possible in the second embodiment are explained with reference to FIG. 12 and FIG. 13. Note that the connections between procedures in the figures are represented by “c2” and “c3.”

At Step S101 in FIG. 12, the control section 12 determines whether or not entrance into the cabin space as the target space CS is sensed.

In a case where it is determined at Step S101 that entrance is not sensed, the control section 12 executes the process at Step S101 again.

On the other hand, in a case where it is determined at Step S101 that entrance is sensed, at Step S120, the control section 12 transmits an instruction to activate the second camera 101 to the vehicle system S.

Then, at Step S121, the control section 12 transmits, to the vehicle system S, an image-capturing instruction to capture an image of the steering wheel H as the particular target object. Note that it is sufficient if the second camera 101 captures an image independently of whether or not the steering wheel H is positioned in its angle of view.

At Step S122, the control section 12 instructs the vehicle system S to perform a process of comparing an image-capturing result of the last calibration (i.e., a second captured image G2) and a current image-capturing result.

In the comparison process, an image area in which an image of the steering wheel H as the particular target object is captured in the second captured image G2 captured the last time and a corresponding image area in the current image-capturing result are compared, and a positional deviation between the image areas (i.e., a positional deviation between the image areas as measured in pixels) is calculated as the difference.

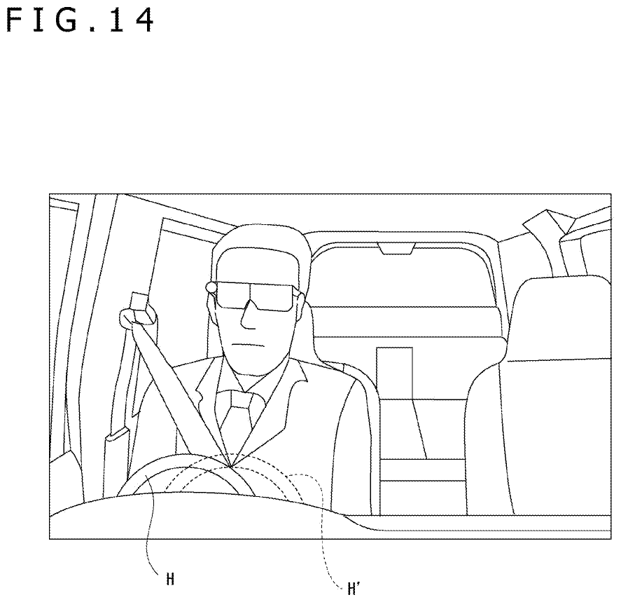

FIG. 14 depicts an example of a second captured image G2 of the cabin space as the target space CS captured with the second camera 101. In the figure, in addition to the steering wheel H drawn with solid lines, a steering wheel H′ drawn with broken lines is depicted. The steering wheel H of the solid lines represents the current position of the steering wheel H. Meanwhile, the steering wheel H′ of the broken lines represents the position of the steering wheel H in a second captured image G2 captured in the past.

In the comparison process based on Step S122, the difference between the positions of the steering wheel H of the solid lines and the steering wheel H′ of the broken lines is calculated.

At Step S123, the control section 12 receives the difference information from the vehicle system S, and determines whether or not the difference is smaller than a threshold. The threshold used here is a threshold for determining whether or not there is such a positional deviation that calibration of second parameters mentioned later cannot be corrected adequately.

In a case where it is determined that the difference is equal to or greater than the threshold, the control section 12 proceeds to Step S124 in FIG. 13, performs a notification process for informing the user that a repair is necessary, and ends the series of processing.

Note that, whereas FIG. 12 depicts an example in which the respective processes at Steps S121, S122, and S123 are executed in accordance with instructions sent from the control section 12 of the HMD 1 to the vehicle control section 32 of the vehicle system S, each process may be executed at the vehicle system S. For example, at Step S120, an instruction to execute the series of processing including activation of the second camera may be transmitted to the vehicle system S. In that case, the processes of capturing an image of the particular target object, comparing the image-capturing results and determining whether or not the difference is smaller than the threshold are executed by the vehicle control section 32 of the vehicle system S, and the control section 12 of the HMD 1 may receive a processing result, in one possible manner of configuration.

In a case where it is determined at Step S123 that the difference is smaller than the threshold, at Step S125 in FIG. 12, the control section 12 performs a process of superimposition-displaying a virtual object VOB on the steering wheel H as the particular target object. Display positions of the virtual object VOB displayed here are both a display position decided on the basis of first estimation information P1 and a display position decided on the basis of second estimation information P2. That is, the user visually recognizes the steering wheel H on which the virtual object VOB is superimposition-displayed on the basis of the first estimation information P1, and next visually recognizes the steering wheel H on which the virtual object VOB is superimposition-displayed on the basis of the second estimation information P2.

At Step S126, the control section 12 prompts to visually recognize the steering wheel H as the particular target object from multiple viewpoints. Then, the control section 12 performs the superimposition display at Step S125 for the multiple viewpoints.

At Step S127 in FIG. 13, the control section 12 acquires and records first estimation information P1 and second estimation information P2 for each of the multiple viewpoints.

At Step S128, the control section 12 performs a presentation process for allowing the user to select an appropriate one of the superimposition position of the virtual object VOB1 based on the first estimation information P1 and the superimposition position of the virtual object VOB2 based on the second estimation information P2.

Specifically, the display processing section 17 performs both the first display process of causing the virtual object VOB1 to be displayed on the basis of the first estimation information P1, and the second display process of causing the virtual object VOB2 to be displayed on the basis of the second estimation information P2. Then, the presentation processing section 23 prompts the user to make selection by presenting choices to the user.

The presentation process may be performed by displaying the choices on the display section 2 or may be performed by using sounds.

After a result of selection by the user in response to the presentation process is acquired, at Step S129, the control section 12 determines whether or not the superimposition position based on the first estimation information P1 is selected as an appropriate one.

In a case where the superimposition position of the virtual object VOB1 based on the first estimation information P1 is selected as an appropriate one, this means that not correction of the first estimation information P1, but correction of the second estimation information P2 is necessary. Conversely, in a case where the superimposition position of the virtual object VOB2 based on the second estimation information P2 is selected as an appropriate one, this means that not correction of the second estimation information P2, but correction of the first estimation information P1 is necessary.

In a case where correction of the first estimation information P1 is necessary, the procedure proceeds to a process at Step S102 in FIG. 8 in the first embodiment, and thereby first parameters used for calculation of the first estimation information P1 are calibrated.

On the other hand, in a case where correction of the second estimation information P2 is necessary, the control section 12 proceeds to Step S130, and determines whether or not calibration is possible.

For example, the determination as to whether or not calibration is possible depends on whether or not it is necessary to set a second parameter such as an internal parameter or an external parameter stored on the parameter retaining section 38 to a value outside an expressible range.

Note that the process at Step S129 and the process at Step S130 are determination processes for doubly performing a check by the user and a check based on numerical values. As a modification example of this, the process at Step S129 may be omitted, and thereby only the check based on numerical values may be performed, or the process at Step S130 may be omitted, and thereby only the check by the user may be performed.

In a case where it is determined that calibration is impossible, the control section 12 proceeds to Step S124, and performs a process of notifying the user that a repair is necessary.

In a case where it is determined that calibration is possible, at Step S131, the control section 12 calibrates the second estimation information P2. For example, the calibration of the second estimation information P2 may be calibration of second parameters used for derivation of the second estimation information P2 or may be determination of a transformation matrix for making information regarding the position and the posture about the display section 2 calculated as the second estimation information P2 closer to a true value.

For example, the following (Formula 3) and (Formula 4) are used for determining a transformation matrix, and making the second estimation information P2 closer to a true value.

Pos=P2·V2·Pose (Formula 3)

Pos=P2·V2′·V2·Pose (Formula 4)

Here, Pose2 in (Formula 3) represents the position and the posture of the steering wheel H in a three-dimensional World coordinate system. Specifically, Pose is an x coordinate, a y coordinate, and a z coordinate representing the position, and a rotation matrix, a quaternion (quaternion), or the like representing the posture.

V2 in (Formula 3) is a transformation matrix for transformation from the World coordinate system to a camera coordinate system of the second camera 101. The transformation matrix V2 represents the position and the posture of the steering wheel H as seen from the second camera 101, and is based on the second estimation information P2.

P2 in (Formula 3) is a transformation matrix for transformation from the camera coordinate system to the screen coordinate system of the left eye area 2a. The transformation matrix P is based on a positional relation between the second camera 101 and the left eye area 2a.

Pos in (Formula 3) represents the pixel position in the screen coordinate system of the left eye area 2a.

If the second estimation information P2 is correct, the user can visually recognize a state where the virtual object VOB is accurately superimposed on the steering wheel H by displaying the virtual object VOB at coordinates (Pos) in the screen coordinate system calculated according to (Formula 3).

However, as mentioned above, the second estimation information P2 is generated on the basis of second parameters which are treated as the target of the calibration since there is a deviation from a correct value due to various types of factor.

Accordingly, the arrangement position of the virtual object VOB in the screen coordinate system of the left eye area 2a needs to be optimized by performing calibration based on the first estimation information P1.

Specifically, the transformation matrix V2′ for transforming information regarding a position and a posture as the second estimation information P2 estimated on the basis of the second captured image G2 into information regarding a position and a posture as the first estimation information P1 estimated on the basis of the first captured image G1 is calculated. The transformation matrix V2′ is a determinant for eliminating an error of the second estimation information P2, and making it closer to a true value on the premise that the first estimation information P1 is correct.

It is possible to optimize the arrangement position of the virtual object VOB in the screen coordinate system of the left eye area 2a by using (Formula 4) including the transformation matrix V2′.

After the calibration of the second estimation information P2 is ended, at Step S113, the control section 12 performs a process of switching to the second mode. Thereby, superimposition display of the virtual object VOB and the like can be performed on the basis of the second estimation information P2 optimized by using the transformation matrix V2′.

### 8. Third Embodiment

In a third embodiment, instead of treating the first estimation information P1 and the second estimation information P2 as information representing the correct position and posture, third estimation information P3 which is a result of estimation of the position and the posture about the display section 2 is calculated by using both the types of estimation information, and a virtual object VOB is superimposition-displayed on the basis of the third estimation information P3.

A specific explanation is given with reference to FIG. 15.

The position of the steering wheel H is identified by using first estimation information P1 which represents a position and a posture of the display section 2 estimated on the basis of a first captured image G1, and a virtual object VOB3 imitating the steering wheel H is arranged at the position.

In addition, the position of the steering wheel H is identified by using second estimation information P2 which represents a position and a posture of the display section 2 estimated on the basis of a second captured image G2, and a virtual object VOB4 imitating the steering wheel H is arranged at the position.

At this time, if there are deviations of the first estimation information P1 and the second estimation information P2 from a true value representing the position of the steering wheel H, the user who has the HMD 1 on visually recognizes a state like the one in FIG. 15.

In this case, the position of the steering wheel H cannot be identified accurately no matter whether the first estimation information P1 is used or the second estimation information P2 is used, and the virtual objects VOB cannot be superimposed accurately on the steering wheel H.

Note that, for ease of understanding, FIG. 15 depicts differences between the virtual objects VOB and the steering wheel H larger than they actually are.

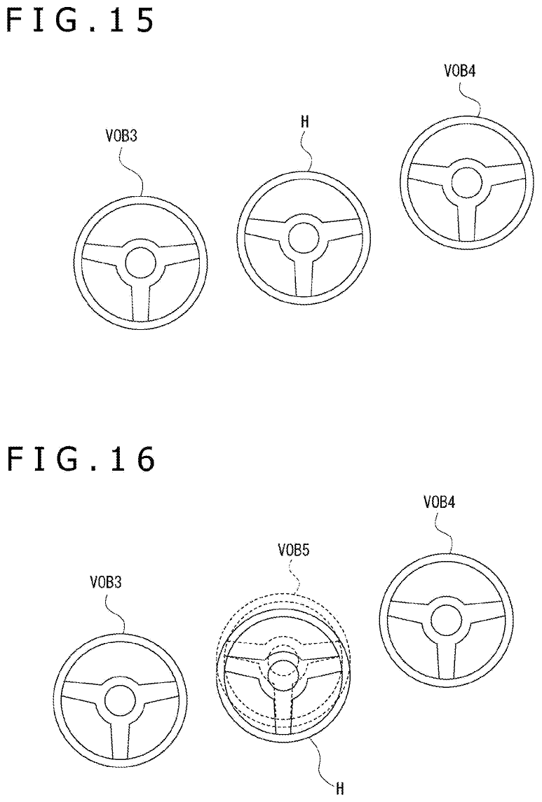

Then, third estimation information P3 is generated on the basis of the first estimation information P1 and the second estimation information P2. For example, an intermediate position between the position and the posture the display section 2 as the first estimation information P1 and the position and the posture of the display section 2 as the second estimation information P2 is defined as the third estimation information P3 about the position and the posture of the display section 2. Then, the position of the steering wheel H is identified by using the third estimation information P3, and a virtual object VOB5 is displayed at the position. An example is depicted in FIG. 16.

As depicted in the figure, the virtual object VOB5 is superimposed such that it substantially overlaps the actual steering wheel H.

In a case where first estimation information P1 and second estimation information P2 are very different from a true value in this manner, third estimation information P3 may be generated by using the first estimation information P1 and the second estimation information P2, and the display position of a virtual object VOB may be decided on the basis of the third estimation information P3.

Note that FIG. 16 depicts an example in which the weights of 1 are given to the first estimation information P1 and the second estimation information P2. By changing the weights of the first estimation information P1 and the second estimation information P2, it becomes possible to make estimation information regarding the position and the posture about the display section 2 closer to a true value.

For example, the technique in the third embodiment is effective in cases such as a case where adequate calibration cannot be performed even by calibrating first estimation information P1, and furthermore calibrating second estimation information P2.

In a case where there is a great deviation of the estimation information regarding the position and the posture about the display section 2 even after calibration is performed or a case where calibration cannot be performed first of all or in other cases, as mentioned above, the user can be notified that a repair is necessary. Then, by generating third estimation information P3 as in the third embodiment until a repair is performed, it becomes possible to substantially accurately superimpose a virtual object VOB temporarily on a real object ROB.

### 9. Modification Examples

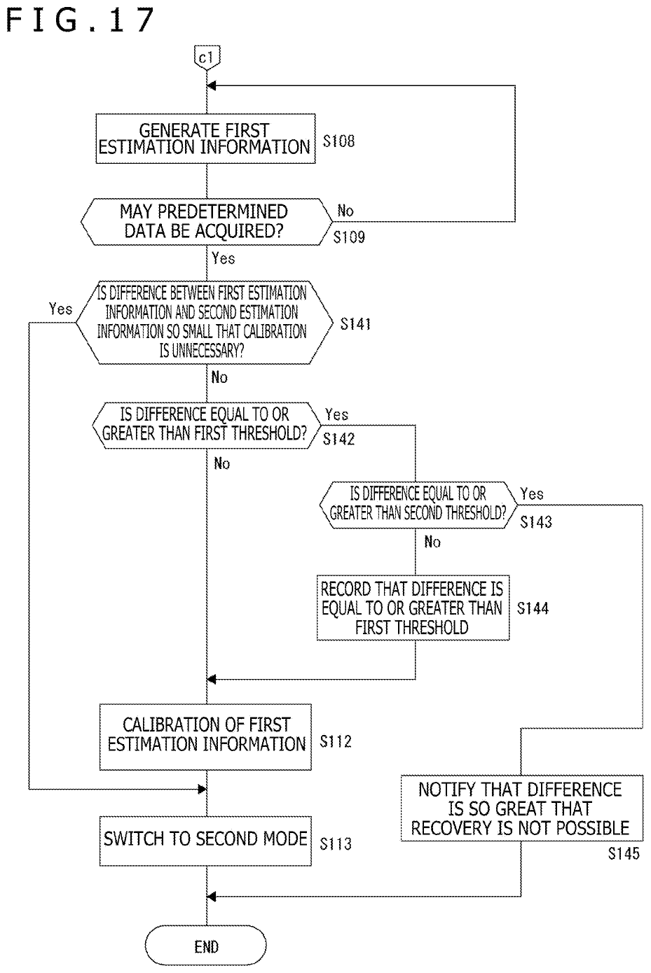

The present modification example is an example in which differences between first estimation information P1 and second estimation information P2 are classified specifically by using multiple pieces of threshold information. The control section 12 in the present modification example executes the processes depicted in FIG. 17 after executing the processes depicted in FIG. 8. Since the processes depicted in FIG. 8 are processes similar to the processes explained in the first embodiment, explanations thereof are omitted in the present modification example. Note that the connection between procedures in FIG. 8 and FIG. 17 is represented by “c1.”

By executing the processes depicted in FIG. 8, the control section 12 of the HMD 1 instructs the vehicle control section 32 to start generation of second estimation information P2.

Next, by executing the processes depicted in FIG. 17, the control section 12 generates first estimation information P1 on the basis of a first captured image G1 captured with the first camera 3, also calculates a difference between the first estimation information P1 and the second estimation information P2, and performs a process according to the magnitude of the difference.

Specifically, the control section 12 generates the first estimation information P1 at Step S108 in FIG. 17, and, at the subsequent Step S109, determines whether or not predetermined data may be acquired. In a case where the predetermined data may not be acquired, the user is instructed to see the steering wheel H from a different angle, and so on, and first estimation information P1 is generated again at Step S108.

On the other hand, in a case where it is determined that the predetermined data may be acquired, at Step S141, the control section 12 determines whether or not the difference between the first estimation information P1 and the second estimation information P2 is so small that calibration is unnecessary. This determination process may be performed by using a threshold.

In a case where the differentiation is so small that calibration is unnecessary, at Step S113, the control section 12 switches to the second mode MD2.

In a case where it is not determined at Step S141 that the difference is so small that calibration is unnecessary, at Step S142, the control section 12 performs a process of comparing the difference and a first threshold Th1. In a case where it is determined as a result of the comparison that the difference is smaller than the first threshold Th1, the control section 12 calibrates the first estimation information P1 at Step S112, and, at the subsequent Step S113, switches to the second mode MD2.

Here, the first threshold Th1 used for the comparison with the difference is a threshold for determining whether calibration is possible, and also is a threshold for determining that it is possible to return to a sufficiently normal state by the calibration.

In a case where it is determined that the difference is equal to or greater than the first threshold Th1, the control section 12 proceeds to Step S143, and compares the difference with a second threshold Th2 greater than the first threshold Th1.

A threshold for determining whether recovery to eliminate the deviation of the first estimation information P1 by calibration is possible is the second threshold Th2.

In a case where it is determined that the difference is smaller than the second threshold Th2, the control section 12 proceeds to Step S144, and performs a process of recording that the difference is equal to or greater than the first threshold Th1. By this process, it is possible to notify the user that a fundamental repair for correcting internal parameters or the like about the first camera 3 will be necessary soon, and so on.

After the recording process, the control section 12 switches to the second mode MD2 by executing Step S112 and Step S113.

On the other hand, in a case where it is determined that the difference is equal to or greater than the second threshold Th2, a process of notifying the user that the difference is so great that recovery is not possible is performed. In this case, switching to the second mode MD2 is not performed.

In this manner, different processes are executed depending on the degrees of deviation of first estimation information P1 and second estimation information P2. Thereby, it is made possible for the user to consider a timing of a repair, and so on.

Another modification example is explained. In the present modification example, when a virtual object VOB is to be superimposed, a tolerance range of the difference between first estimation information P1 and second estimation information P2 is decided on the basis of the superimposition precision required depending on scenes.

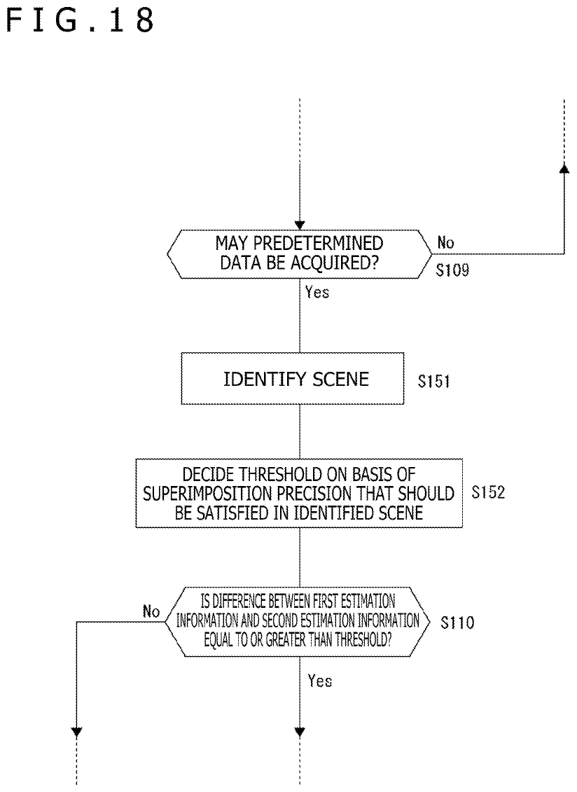

FIG. 18 specifically depicts a flowchart in which a part of the flowchart depicted in FIG. 8 and FIG. 9 is modified. Note that, after the processes from Step S101 to Step S109 depicted in FIG. 8 are executed, the control section 12 of the HMD 1 in the present modification example executes Step S151 and Step S152 depicted in FIG. 18, and executes the processes at Step S110 to Step S114 depicted in FIG. 9. Explanations of processes mentioned before are omitted.

In a case where the control section 12 determines that the predetermined data may be acquired at Step S109, that is, in a case where the control section 12 determines that first estimation information P1 and second estimation information P2 which are results of estimation of the position and the posture of the display section 2 when the steering wheel H is seen from multiple angles may be acquired, the control section 12 identifies the scene at Step S151. The scene is identified on the basis of a first captured image G1 captured with the first camera 3, a second captured image G2 captured with the second camera 101, and information acquired from other sensors.

For example, it is identified whether the current scene is a driving scene or a stopped scene, and so on. In a case of a driving scene, it is possible to ensure the safety by preventing undesirable occurrence of unnecessary confusion to the user who is the driver by increasing the superimposition precision.

Alternatively, as mentioned before, the scene may be identified on the basis of a superimposition-target real object ROB.

After the scene is identified, at Step S152, the control section 12 decides a threshold on the basis of the superimposition precision that should be satisfied in the identified scene. The threshold decided here is a threshold for determining whether or not the difference between the first estimation information P1 and the second estimation information P2 is tolerable. A low threshold is decided for a scene for which high superimposition precision is required, and a high threshold is decided for a scene for which low superimposition precision is tolerated.

After the threshold is decided, the control section 12 proceeds to Step S110, and determines whether or not the difference between the first estimation information P1 and the second estimation information P2 is equal to or greater than the threshold.

By deciding an appropriate threshold for each scene in this manner, the control section 12 can flexibly execute calibration and notify that calibration is not possible. In addition, thereby, undesirable execution of unnecessary calibration in a scene where low superimposition precision is tolerated is suppressed, and also appropriate calibration can be executed in a scene for which high superimposition precision is required.

In each example mentioned before, the user is positioned in the target space CS by getting in the vehicle 100 with the HMD 1 on, and also various types of processes about calibration are executed. However, the target space CS does not have to be a space related to a mobile body such as the vehicle 100. For example, an entrance or the like of a facility such as a shopping mall or a stadium is treated as the target space CS, and by performing appropriate calibration in the target space CS when the user enters the facility from the entrance, it becomes possible to appropriately perform a process of superimposing a virtual object VOB for presenting information regarding each shop that is in business in the shopping mall or to appropriately perform a process of superimposing a virtual object VOB for presenting information regarding a sport game or a concert played or held at the stadium.

### 10. Summary

As explained in each example mentioned above, the HMD 1 as an information processing apparatus in the present technology includes the acquiring section 19 that acquires first estimation information P1 representing a position and a posture of the display section 2 estimated on the basis of a first captured image G1 captured with the first camera 3 worn by the user along with the display section 2, and second estimation information P2 representing a position and a posture of the display section 2 estimated on the basis of a second captured image G2 captured with the second camera 101 installed in the space (target space CS) where the user exists, and the calibration processing section 21 that generates correction information used for calibration of a parameter used for estimation of the position and the posture of the display section 2 on the basis of the first estimation information P1 and the second estimation information P2.

Thereby, it becomes possible to calibrate parameters used for estimation of the position and the posture of the display section 2 without arranging observation cameras for calibration at positions corresponding to eyes of the user.

Accordingly, calibration processes can be realized with a simple configuration. In addition, calibration can be executed by causing the user to move to the space where the second camera 101 is arranged. Stated differently, it becomes possible to calibrate calibration-target equipment such as the HMD 1 even in a state where the user is using the equipment, and it is possible to attempt to enhance the convenience.

The calibration processing section 21 may calibrate parameters used for estimation of the position and the posture of the display section 2 by using correction information. For example, the correction information is information that identifies calibration-target parameters, or the like.

By calibrating parameters, it is possible to enhance the precision of estimation of the position and the posture of the display section 2, and it is possible to present information to be visually recognized by the user, or the like at appropriate positions.

The HMD 1 may include the determining section 20 that determines whether or not to execute the calibration.

By determining whether or not execution of calibration is possible, undesirable execution of unnecessary calibration processes can be suppressed, and it is possible to attempt to mitigate the processing load of an apparatus that performs calibration processes.

As explained with reference to FIG. 13 and the like, the determining section 20 may determine whether or not to execute the calibration, on the basis of whether or not the parameter is outside an expressible range.

For example, in a case where the parameter needs to be set to a value outside the expressible range, it is determined that the calibration is impossible.

Thereby, undesirable execution of unnecessary calibration processes is prevented.

As explained with reference to FIG. 17 and the like, in the process of determining whether or not to execute the calibration, the determining section 20 may determine that calibration is unnecessary in a case where the difference between the first estimation information P1 and the second estimation information P2 is smaller than a threshold.

It is considered that advantageous effects attained by the calibration are small in a case where the difference is small. In addition, it is likely that there will not be disadvantageous effects to the user even if the calibration is not performed.

By determining that the calibration is unnecessary in such a case, the processing load on an apparatus that executes calibration processes can be mitigated.

As explained with reference to FIG. 3 and the like, the second estimation information P2 may be information regarding a position and a posture of the display section 2 estimated on the basis of the second captured image G2 captured such that a predetermined location on the housing (HMD 1) having the display section 2 can be identified.

The position and the posture of the display section 2 are estimated relative to a predetermined portion on the apparatus that is worn integrally with the display section 2, stated differently, a location whose positional relation with the display section 2 does not change basically.

Thereby, a result of estimation of a position and a posture of the display section 2 can be estimated more accurately, and accordingly it becomes possible to perform appropriate calibration.

As explained with reference to FIG. 3 and the like, the second estimation information P2 may be information regarding a position and a posture of the display section 2 that are estimated on the basis of the second captured image G2 capturing an image of the marker 13 provided at the predetermined location.

By providing the marker 13 at the predetermined location, estimation of the position and the posture of the display section 2 from the second captured image G2 becomes easier, and also accurate estimation becomes possible.

Accordingly, it becomes possible to perform appropriate calibration.

As explained with reference to FIG. 9 and the like, the calibration processing section 21 may perform the calibration in a case where the difference between the first estimation information P1 and the second estimation information P2 is equal to or greater than a threshold.

In a case where the difference between the first estimation information P1 and the second estimation information P2 is great, the superimposition position of a virtual object VOB or the like deviates too much from a correct position undesirably, and there is a possibility that inappropriate information is presented to the user undesirably. On the other hand, in a case where the difference is small, the superimposition position of the virtual object VOB can be at a substantially correct position, and accordingly it becomes likely that appropriate information can be presented to the user. Since it is decided whether or not to perform the calibration depending on the magnitude of the difference according to the present configuration, necessary calibration can be performed, and also undesirable execution of calibration which is more than necessary can be prevented.

Accordingly, it is possible to prevent inappropriate information presentation to the user, and also it is possible to attempt to mitigate the processing load on the HMD 1 as the information processing apparatus. In addition, by appropriately setting the threshold, it is possible to attain advantageous effects related to prevention of inappropriate information presentation and advantageous effects related to mitigation of the processing load in a well-balanced manner.

As explained with reference to FIG. 9 and the like, the calibration processing section 21 may perform the calibration about a first parameter used for estimation of the first estimation information P1.

Thereby, the inaccuracy of the first estimation information P1 is ameliorated.

Accordingly, the position, orientation, or the like of a virtual object VOB superimposed by using the first estimation information P1 can be optimized, and the possibility of presentation of appropriate information to the user can be enhanced.

As explained with reference to a configuration example or the like of the HMD 1, the first parameter may be a parameter for identifying a positional relation between the first camera 3 and the display section 2.

The positional relation between the first camera 3 and the display section 2 can change depending on use conditions, aging, or the like, even if they are parts of equipment like the integrated HMD 1. Even in such a case, the latest positional relation between the first camera 3 and the display section 2 is redefined according to the present configuration.

Thereby, a deviation of the first estimation information P1 can be calibrated appropriately, and it becomes possible to accurately arrange a virtual object VOB or the like.

As explained with reference to a configuration example or the like of the HMD 1, the first parameter may include at least any one of the optical-axis direction, focal length, and distortion of the first camera 3.

The parameter (internal parameter) such as the optical-axis direction of the first camera 3 can change depending on aging or the like. Even in such a case, the internal parameter is recalculated, and set appropriately according to the present configuration.

Thereby, a deviation of the first estimation information P1 can be calibrated appropriately, and it becomes possible to accurately arrange a virtual object VOB or the like.

As explained with reference to configuration or the like of the vehicle system S, the calibration processing section 21 of the HMD 1 may perform a process for causing the vehicle system S to execute calibration of a second parameter used for estimation of the second estimation information P2, as the calibration mentioned above. Specifically, the calibration processing section 21 may cause the calibration processing section 37 included in the vehicle system S to execute the calibration of the second parameter by sending a command for executing the calibration to the calibration processing section 37.

Thereby, the inaccuracy of the second estimation information P2 is ameliorated.

Accordingly, the position, orientation, or the like of a virtual object VOB superimposed by using the second estimation information P2 can be optimized, and the possibility of presentation of appropriate information to the user can be enhanced.

As explained with reference to a configuration example or the like of the HMD 1, the second parameter may include at least any one of the optical-axis direction, focal length, and distortion of the second camera 101.

The parameter (internal parameter) such as the optical-axis direction of the second camera 101 can change depending on aging or the like. Even in such a case, the internal parameter is recalculated, and set appropriately according to the present configuration.

Thereby, a deviation of the second estimation information P2 can be calibrated appropriately, and it becomes possible to accurately arrange a virtual object VOB or the like.

As explained with reference to a configuration example of the HMD 1 or FIG. 14 and the like, the calibration processing section 21 may perform calibration of the second parameter on the basis of an image capturing area of the particular target object (e.g., the steering wheel H) in the second captured image G2.

Thereby, for example, in a case where the particular target object such as the steering wheel H is captured in an image capturing area which is different from an image capturing area in a previously-captured image or in other cases, it is determined that there is a deviation of the optical-axis direction of the second camera 101, and it becomes possible to execute the calibration of the second parameter.

Accordingly, it becomes possible to estimate a position and a posture of the display section 2 more accurately by performing the calibration of the second parameter, even in a case where a position and a posture of the display section 2 cannot be estimated accurately only with the calibration of the first parameter. Then, a virtual object VOB can be displayed at a desired position.

As explained with reference to the first embodiment and the like by using FIG. 8 and FIG. 9, the calibration processing section 21 may perform the calibration when the first mode MD1 in which a predetermined process is performed by using the first estimation information P1 is switched to the second mode MD2 in which the predetermined process is performed by using the second estimation information P2.

For example, the mode is switched to the second mode MD2 when the user moves to the space (target space CS) where the second camera 101 is arranged in a state where the user has the equipment such as the HMD 1 including the first camera 3 on. Then, the timing at which the user has moved to the space where the second camera 101 is arranged is a timing suited for performing the calibration mentioned before using the first camera 3 and the second camera 101.

By performing the calibration when the mode is switched to the second mode MD2, a virtual object VOB can be superimposition-displayed appropriately while the user is positioned in the space.

Then, by realizing a configuration that automatically performs the calibration when the user moves to the space, it is not necessary for the user to intentionally and manually perform manipulation for performing the calibration, and accordingly it is possible to enhance the convenience for the user.

As explained by using FIG. 3 and the like, the information processing apparatus may include the synchronization processing section 22 that synchronizes the first camera 3 and the second camera 101.

By synchronizing the first camera 3 and the second camera 101, it is possible to perform the calibration by using the first captured image G1 and the second captured image G2 captured at the same timing or close timings.

Accordingly, since comparison of the first estimation information P1 and the second estimation information P2 can be performed appropriately, it is possible to attempt to attain higher precision of calibration processes, and to reduce the difference between the first estimation information P1 and the second estimation information P2.

As explained with reference to FIG. 9 and the like, the calibration processing section 21 may perform a process of comparing image-capturing times of the first captured image G1 used for estimation of the first estimation information P1 and the second captured image G2 used for estimation of the second estimation information P2 used for the calibration, and perform the calibration on the basis of the first estimation information P1 and the second estimation information P2 estimated on the basis of the first captured image G1 and the second captured image G2 whose image-capturing times are determined to have a difference which is smaller than a threshold.

Thereby, the calibration is performed by using the first captured image G1 and the second captured image G2 captured at the same timing or close timings.

Accordingly, appropriate comparison of the first estimation information P1 and the second estimation information P2 is performed, and it is possible to attempt to attain higher precision of calibration processes.

As explained with reference to FIG. 8 and the like, the synchronization processing section 22 may perform synchronization on the basis of round-trip time of data transmitted to the control section (vehicle control section 32) of the second camera 101.

Thereby, it becomes possible to select a first captured image G1 and a second captured image G2 taking into consideration time required for communication between the first camera 3 (or the HMD 1 on which the first camera 3 is mounted) and the second camera 101 (or the vehicle system S on which the second camera is mounted).

Accordingly, it becomes possible to perform highly-precise calibration by using the first captured image G1 and the second captured image G2 captured at close timings.

As explained with reference to FIG. 3, FIG. 13, and the like, the information processing apparatus may include the display processing section 17 that can execute a first display process of superimposing a virtual object VOB on the basis of the first estimation information P1, and a second display process of superimposing the virtual object VOB on the basis of the second estimation information P2, and the presentation processing section 23 that presents choices for allowing selection of either the virtual object VOB1 superimposed by the first display process or the virtual object VOB2 superimposed by the second display process.

Thereby, it becomes possible for the user to select either the first display process or the second display process depending on her/his preference.

Accordingly, it becomes possible to superimpose a virtual object VOB by using estimation information which is appropriate for the user, and so on.

In addition, it becomes possible to perform calibration for calibrating estimation information which was not selected.

The information processing apparatus may be the head mounted display apparatus (HMD 1) including the acquiring section 19 and the calibration processing section 21.

Thereby, it becomes possible to execute calibration processes by moving to the space where the second camera 101 is arranged in a state where the user has the HMD 1 on.

In addition, since it is not necessary to arrange observation cameras at positions corresponding to the eyes of the user, it is possible to perform the calibration while the user has the HMD 1 on.

As mentioned above, the target space CS as a space where the user exists may be the inner space (cabin space) of a mobile body such as the vehicle 100.

By performing the calibration as mentioned above even if the target space CS is the inner space of the mobile body, it becomes possible to calibrate parameters used for estimation of the position and the posture of the display section 2 appropriately independently of the motion of the vehicle 100 as the mobile body.

An information processing method in the present technology is executed by a computer apparatus, and includes processes of acquiring first estimation information P1 representing a position and a posture of the display section 2 estimated on the basis of a first captured image G1 captured with the first camera 3 worn by the user along with the display section 2, and second estimation information P2 representing a position and a posture of the display section 2 estimated on the basis of a second captured image G2 captured with the second camera 101 installed in the space (target space CS) where the user is, and generating correction information used for calibration of a parameter used for estimation of the position and the posture of the display section 2 on the basis of the first estimation information P1 and the second estimation information P2.

A storage medium in the present technology is a computer-apparatus-readable storage medium that has stored thereon a program that causes a computation processing apparatus to execute functions of acquiring first estimation information P1 representing a position and a posture of the display section 2 estimated on the basis of a first captured image G1 captured with the first camera 3 worn by the user along with the display section 2, and second estimation information P2 representing a position and a posture of the display section 2 estimated on the basis of a second captured image G2 captured with the second camera 101 installed in the space (target space CS) where the user is, and generating correction information used for calibration of a parameter used for estimation of the position and the posture of the display section 2 on the basis of the first estimation information P1 and the second estimation information P2.

A program that a computation an information apparatus (HMD 1) is caused to execute is a program that causes a computation processing apparatus such as a CPU included in the HMD 1, for example, to execute functions of acquiring first estimation information P1 representing a position and a posture of the display section 2 estimated on the basis of a first captured image G1 captured with the first camera 3 worn by the user along with the display section 2, and second estimation information P2 representing a position and a posture of the display section 2 estimated on the basis of a second captured image G2 captured with the second camera 101 installed in the space (target space CS) where the user is, and generating correction information used for calibration of a parameter used for estimation of the position and the posture of the display section 2 on the basis of the first estimation information P1 and the second estimation information P2.

By such programs, the calibration processes mentioned above can be realized by a computation processing apparatus such as a microcomputer.

These programs can be recorded in advance on an HDD (Hard Disk Drive) as a recording medium built in equipment such as a computer apparatus, a ROM in a microcomputer having a CPU, or the like. Alternatively, the programs can be stored (recorded) temporarily or permanently on a removable recording medium such as a flexible disc, a CD-ROM (Compact Disk Read Only Memory), an MO (Magneto Optical) disc, a DVD (Digital Versatile Disc), a Blue-ray disc (Blu-ray Disc (registered trademark)), a magnetic disc, a semiconductor memory, or a memory card. Such a removable recording medium can be provided as generally-called package software.

In addition, such programs can also be downloaded from a download site via a network such as a LAN (Local Area Network) or the Internet, other than being installed from a removable recording medium on a personal computer or the like.

In addition, an information processing system according to the present technology includes the first camera 3 worn by the user along with the display section 2, the second camera 101 installed in the space (target space CS) where the user is, the acquiring section 19 that acquires first estimation information P1 representing a position and a posture of the display section 2 estimated on the basis of a first captured image G1 captured with the first camera 3, and second estimation information P2 representing a position and a posture of the display section 2 estimated on the basis of a second captured image G2 captured with the second camera 101, and the calibration processing section 21 that generates correction information used for calibration of a parameter used for estimation of the position and the posture of the display section 2 on the basis of the first estimation information P1 and the second estimation information P2.

Note that advantageous effects described in the present specification are presented merely for illustrative purposes, and not for limiting the advantageous effects. There may be other advantageous effects.

In addition, examples mentioned above may be combined in any manner, and, even in a case where various types of combination are used, various actions and advantageous effects mentioned above can be attained.

### 11. Present Technology

The present technology can also be implemented in such following configurations.

(1)
An information processing apparatus including:
an acquiring section that acquires first estimation information representing a position and a posture of a display section that are estimated on the basis of a first captured image captured with a first camera worn by a user along with the display section, and second estimation information representing a position and a posture of the display section that are estimated on the basis of a second captured image captured with a second camera installed in a space where the user exists; and
a calibration processing section that generates correction information used for calibration of a parameter of either the first camera or the second camera on the basis of the first estimation information and the second estimation information.
   (2)
The information processing apparatus according to (1) above, in which the calibration processing section calibrates the parameter used for estimation of the position and the posture of the display section by using the correction information.
   (3)
The information processing apparatus according to any one of (1) to (2) above, including:
a determining section that determines whether or not to execute the calibration, in which
the determining section performs the determination on the basis of whether or not the parameter is outside an expressible range.
   (4)
The information processing apparatus according to any one of (1) to (2) above, including:
a determining section that determines whether or not to execute the calibration, in which
the determining section determines that calibration is unnecessary in a case where, in the determination, a difference between the first estimation information and the second estimation information is smaller than a threshold.
   (5)
The information processing apparatus according to any one of (1) to (4) above, in which the second estimation information is assumed to be information regarding the position and the posture of the display section that are estimated on the basis of the second captured image captured such that a predetermined location on a housing having the display section is identifiable.
   (6)
The information processing apparatus according to (5) above, in which the second estimation information is assumed to be information regarding the position and the posture of the display section that are estimated on the basis of the second captured image capturing an image of a marker provided at the predetermined location.
   (7)
The information processing apparatus according to any one of (1) to (6) above, in which the calibration processing section performs the calibration in a case where the difference between the first estimation information and the second estimation information is equal to or greater than a threshold.
   (8)
The information processing apparatus according to any one of (1) to (7) above, in which the calibration processing section performs the calibration about a first parameter used for estimation of the first estimation information.
   (9)
The information processing apparatus according to (8) above, in which the first parameter is assumed to be a parameter for identifying a positional relation between the first camera and the display section.
   (10)
The information processing apparatus according to (8) above, in which the first parameter includes at least any one of an optical-axis direction, a focal length, and a distortion of the first camera.
   (11)
The information processing apparatus according to any one of (1) to (10) above, in which the calibration processing section performs the calibration for a second parameter used for estimation of the second estimation information.
   (12)
The information processing apparatus according to (11) above, in which the second parameter includes at least any one of an optical-axis direction, a focal length, and a distortion of the second camera.
   (13)
The information processing apparatus according to any one of (11) to (12) above, in which the calibration processing section performs calibration of the second parameter on the basis of an image capturing area of a particular target object in the second captured image.
   (14)
The information processing apparatus according to any one of (1) to (13) above, in which the calibration processing section performs the calibration when a first mode in which a predetermined process is performed by using the first estimation information is switched to a second mode in which the predetermined process is performed by using the second estimation information.
   (15)
The information processing apparatus according to any one of (1) to (14) above, in which the calibration processing section performs a process of comparing image-capturing times of the first captured image used for estimation of the first estimation information and the second captured image used for estimation of the second estimation information that are used for the calibration, and performs the calibration on the basis of the first estimation information and the second estimation information estimated on the basis of the first captured image and the second captured image whose image-capturing times are determined to have a difference which is smaller than a threshold.
   (16)
The information processing apparatus according to any one of (1) to (15) above, including:
a display processing section that executes a first display process of superimposing a virtual object on the basis of the first estimation information, and a second display process of superimposing the virtual object on the basis of the second estimation information; and
a presentation processing section that presents choices for allowing selection of either the virtual object superimposed by the first display process or the virtual object superimposed by the second display process.
   (17)
The information processing apparatus according to any one of (1) to (16) above, in which the information processing apparatus is assumed to be a head mounted display apparatus including the acquiring section and the calibration processing section.
   (18)
The information processing apparatus according to any one of (1) to (17) above, in which the space where the user exists is assumed to be an inner space of a mobile body.
   (19)
An information processing method executed by a computer apparatus, the information processing method including processes of:
acquiring first estimation information representing a position and a posture of a display section that are estimated on the basis of a first captured image captured with a first camera worn by a user along with the display section, and second estimation information representing a position and a posture of the display section that are estimated on the basis of a second captured image captured with a second camera installed in a space where the user exists; and
generating correction information used for calibration of a parameter of either the first camera or the second camera on the basis of the first estimation information and the second estimation information.
   (20)
A storage medium being read by a computer and having stored thereon a program that causes a computation processing apparatus to execute functions of:
acquiring first estimation information representing a position and a posture of a display section that are estimated on the basis of a first captured image captured with a first camera worn by a user along with the display section, and second estimation information representing a position and a posture of the display section that are estimated on the basis of a second captured image captured with a second camera installed in a space where the user exists; and
generating correction information used for calibration of a parameter of either the first camera or the second camera on the basis of the first estimation information and the second estimation information.

### REFERENCE SIGNS LIST

1: HMD (information processing apparatus)
2: Display section
3: First camera
13: Marker
17: Display processing section
19: Acquiring section
21: Calibration processing section
22: Synchronization processing section
23: Presentation processing section
101: Second camera
CS: Target space (space)
G1: First captured image
G2: Second captured image
MD1: First mode
MD2: Second mode
P1: First estimation information
P2: Second estimation information

1. An information processing apparatus comprising:
an acquiring section that acquires first estimation information representing a position and a posture of a display section that are estimated on a basis of a first captured image captured with a first camera worn by a user along with the display section; and second estimation information representing a position and a posture of the display section that are estimated on a basis of a second captured image captured with a second camera installed in a space where the user exists; and
a calibration processing section that generates correction information used for calibration of a parameter of either the first camera or the second camera on a basis of the first estimation information and the second estimation information.

2. The information processing apparatus according to claim 1, wherein the calibration processing section calibrates the parameter used for estimation of the position and the posture of the display section by using the correction information.

3. The information processing apparatus according to claim 1, comprising:
a determining section that determines whether or not to execute the calibration, wherein
the determining section performs the determination on a basis of whether or not the parameter is outside an expressible range.

4. The information processing apparatus according to claim 1, comprising:
a determining section that determines whether or not to execute the calibration, wherein
the determining section determines that calibration is unnecessary in a case where, in the determination, a difference between the first estimation information and the second estimation information is smaller than a threshold.

5. The information processing apparatus according to claim 1, wherein the second estimation information is assumed to be information regarding the position and the posture of the display section that are estimated on a basis of the second captured image captured such that a predetermined location on a housing having the display section is identifiable.

6. The information processing apparatus according to claim 5, wherein the second estimation information is assumed to be information regarding the position and the posture of the display section that are estimated on a basis of the second captured image capturing an image of a marker provided at the predetermined location.

7. The information processing apparatus according to claim 1, wherein the calibration processing section performs the calibration in a case where the difference between the first estimation information and the second estimation information is equal to or greater than a threshold.

8. The information processing apparatus according to claim 1, wherein the calibration processing section performs the calibration about a first parameter used for estimation of the first estimation information.

9. The information processing apparatus according to claim 8, wherein the first parameter is assumed to be a parameter for identifying a positional relation between the first camera and the display section.

10. The information processing apparatus according to claim 8, wherein the first parameter includes at least any one of an optical-axis direction, a focal length, and a distortion of the first camera.

11. The information processing apparatus according to claim 1, wherein the calibration processing section performs the calibration for a second parameter used for estimation of the second estimation information.

12. The information processing apparatus according to claim 11, wherein the second parameter includes at least any one of an optical-axis direction, a focal length, and a distortion of the second camera.

13. The information processing apparatus according to claim 11, wherein the calibration processing section performs calibration of the second parameter on a basis of an image capturing area of a particular target object in the second captured image.

14. The information processing apparatus according to claim 1, wherein the calibration processing section performs the calibration when a first mode in which a predetermined process is performed by using the first estimation information is switched to a second mode in which the predetermined process is performed by using the second estimation information.

15. The information processing apparatus according to claim 1, wherein the calibration processing section performs a process of comparing image-capturing times of the first captured image used for estimation of the first estimation information and the second captured image used for estimation of the second estimation information that are used for the calibration, and performs the calibration on a basis of the first estimation information and the second estimation information estimated on a basis of the first captured image and the second captured image whose image-capturing times are determined to have a difference which is smaller than a threshold.

16. The information processing apparatus according to claim 1, comprising:
a display processing section that executes a first display process of superimposing a virtual object on a basis of the first estimation information, and a second display process of superimposing the virtual object on a basis of the second estimation information; and
a presentation processing section that presents choices for allowing selection of either the virtual object superimposed by the first display process or the virtual object superimposed by the second display process.

17. The information processing apparatus according to claim 1, wherein the information processing apparatus is assumed to be a head mounted display apparatus including the acquiring section and the calibration processing section.

18. The information processing apparatus according to claim 1, wherein the space where the user exists is assumed to be an inner space of a mobile body.

19. An information processing method executed by a computer apparatus, the information processing method comprising processes of:
acquiring first estimation information representing a position and a posture of a display section that are estimated on a basis of a first captured image captured with a first camera worn by a user along with the display section, and second estimation information representing a position and a posture of the display section that are estimated on a basis of a second captured image captured with a second camera installed in a space where the user exists; and
generating correction information used for calibration of a parameter of either the first camera or the second camera on a basis of the first estimation information and the second estimation information.

20. A storage medium being read by a computer and having stored thereon a program that causes a computation processing apparatus to execute functions of:
acquiring first estimation information representing a position and a posture of a display section that are estimated on a basis of a first captured image captured with a first camera worn by a user along with the display section, and second estimation information representing a position and a posture of the display section that are estimated on a basis of a second captured image captured with a second camera installed in a space where the user exists; and
generating correction information used for calibration of a parameter of either the first camera or the second camera on a basis of the first estimation information and the second estimation information.
